(19) United States
(12) Patent Application Publication
(10) Pub. No.: US 2025/0376367 A1
(43) Pub. Date: Dec. 11, 2025

(54) SYSTEMS AND METHODS FOR DISPENSING A BEVERAGE

(71) Applicant: PepsiCo, Inc., Purchase, NY (US)

(72) Inventors: Julia BURKE, New York, NY (US); Hao Wei DING, Shenzhen (CN); Giancarlo FANTAPPIE, Rancho Palos Verdes, CA (US); Carlos GONZALEZ, Purchase, NY (US); Farshad KAMALI, Purchase, NY (US); Monty KIM, Purchase, NY (US); Anton LJUNGGREN, Purchase, NY (US); Steven JERSEY, Laguna Niguel, CA (US); Diego MACRELLINO, Torrance, CA (US); Ke Jun WEI, Shenzhen (CN)

(21) Appl. No.: 18/972,309

(22) Filed: Dec. 6, 2024

Related U.S. Application Data
(60) Provisional application No. 63/608,117, filed on Dec. 8, 2023.

(51) Int. Cl. B67D 1/00; B67D 1/08

(52) U.S. Cl. CPC B67D 1/008; B67D 1/0037; B67D 1/0888; B67D 2210/0001

(57) ABSTRACT

Embodiments described herein provide a self-contained, above-the-counter beverage dispenser that allows for personalization of flavor intensity, temperature, and carbonation levels. The system can have a small form factor that allows it to sit on a countertop and below upper cabinetry. The dispenser can dispense carbonated beverages, still beverages, flavored beverages, hot beverages, cold beverages, and combinations thereof. Moreover, unlike existing systems, embodiments described herein may maintained by a user without special training, tools, or technical expertise. The dispenser can include consumable components, such as ingredient cartridges, a gas cylinder, and a filter. Each of these consumable components can be replaced easily without any tools or special training or expertise. Additionally, all consumables can be accessible behind a door on the front of the machine, making them readily accessible by only opening the front door.

### CROSS-REFERENCE

This application claims the benefit of U.S. Provisional Application No. 63/608,117, filed Dec. 8, 2023, which is incorporated herein in its entirety by reference thereto.

### BACKGROUND

The present disclosure relates to systems for dispensing a beverage (e.g., a carbonated and/or flavored beverage). More specifically, the present disclosure relates to dispensing systems with consumable products that can be easily replaced by the end user. The system can, for example, dispense customized beverages with various levels of flavors, carbonation, temperatures, etc.

### BRIEF SUMMARY

Some embodiments are directed to a water filter cartridge mount for a beverage dispenser. The water filter mount can include a wall; a slot configured to receive a first portion of a water filter cartridge; and a filter coupling assembly. The filter coupling assembly can include a receptacle for receiving a second portion of the water filter cartridge, a water inlet in fluid communication with a water source; a water outlet; a valve; and a lever system.

In any of the various embodiments discussed herein, the filter coupling assembly is configured to secure the water filter cartridge to the water filter mount. In any of the various embodiments discussed herein, the filter coupling assembly is configured to be moved between a sealed position and an unsealed position. In any of the various embodiments discussed herein, the filter coupling assembly is configured to be sealingly coupled to the water filter cartridge in the sealed position. In any of the various embodiments discussed herein, the filter coupling assembly is not coupled to the water filter cartridge in the unsealed position.

In any of the various embodiments discussed herein, the lever system can be coupled to the filter coupling assembly and can include a lever configured to move between a closed position and an open position. In any of the various embodiments discussed herein, the filter coupling assembly is configured to move from the unsealed position to the sealed position in response to the lever moving from the open position to the closed position.

In any of the various embodiments discussed herein, the lever is rotatable about an axis, and the filter coupling assembly is movable vertically between the sealed position and the unsealed position.

In any of the various embodiments discussed herein, the lever system is coupled to the filter coupling assembly by a cam such that the filter coupling assembly moves vertically up in response to the lever moving from the closed position to the open position and the filter coupling assembly moves vertically down in response to the lever moving from the open position to the closed position.

In any of the various embodiments discussed herein, the water filter cartridge mount includes a first C-shaped rim extending perpendicular out from the wall; and a second C-shaped rim disposed below the first C-shaped rim, the second C-shaped rim extending perpendicular out from the wall. In any of the various embodiments discussed herein, the slot is defined by a space between the first C-shaped rim and the second C-shaped rim.

In any of the various embodiments discussed herein, the second C-shaped rim extends out from the wall farther than the first C-shaped rim.

In any of the various embodiments discussed herein, the open position is about 90 degrees relative to the closed position.

In any of the various embodiments discussed herein, the water filter cartridge mount includes the water filter cartridge. In any of the various embodiments discussed herein, the water filter cartridge includes a filter head comprising a flange, a filter water inlet, and a filter water outlet; a filter housing coupled to the filter head, and filter media disposed within the filter housing.

In any of the various embodiments discussed herein, the water filter cartridge mount includes a water flow path that is formed when the lever is in the closed position and the filter coupling assembly is in the sealed position, and the flow path extends from the water inlet and through the filter water inlet, the filter media, the filter water outlet, and the water outlet.

In any of the various embodiments discussed herein, the slot is configured to receive the flange.

In any of the various embodiments discussed herein, the filter head comprises a valve disposed at the filter water inlet, and the valve is configured to open only when water pressure is applied to the valve.

In any of the various embodiments discussed herein, the valve of the filter coupling assembly is a check valve.

In any of the various embodiments discussed herein, the water outlet is in fluid communication with at least one of a nozzle of the beverage dispenser, a refrigeration system, or a heating system.

In any of the various embodiments discussed herein, the valve is configured to open only when water pressure is applied.

Some embodiments are directed to a gas cylinder mount for a beverage dispenser that includes a wall; a slot configured to receive a portion of a gas cylinder; a gas cylinder coupling assembly; and a lever. The gas cylinder coupling assembly can include a receptacle for receiving a head of the gas cylinder, a regulator configured fluidly couple to the gas cylinder. The gas cylinder coupling assembly can be configured to secure the gas cylinder to the gas cylinder mount.

In any of the various embodiments discussed herein, the gas cylinder coupling assembly is configured to be moved between an unsealed position, a locked position, and a sealed position. In any of the various embodiments discussed herein, the gas cylinder coupling assembly is configured to be sealingly coupled to the gas cylinder in the sealed position. In any of the various embodiments discussed herein, the gas cylinder coupling assembly is not coupled to the gas cylinder in the unsealed position

In any of the various embodiments discussed herein, the lever system is coupled to the gas cylinder coupling assembly and the lever system includes a lever configured to move between an open position, an intermediate position, and a closed position. In any of the various embodiments discussed herein, the gas cylinder assembly is configured to move from the unsealed position to the locked position in response to the lever moving from the open position to the intermediate position. In any of the various embodiments discussed herein, the gas cylinder assembly is configured to move from the locked position to the sealed position in response to the lever moving from the intermediate position to the closed position.

In any of the various embodiments discussed herein, the lever is rotatable about an axis, and wherein the a gas cylinder coupling assembly is movable vertically between the unsealed position, the locked position, and the sealed position.

In any of the various embodiments discussed herein, the open position is about 90 degrees relative to the closed position, and the intermediate position is about 10 degrees to about 30 degrees relative to the closed position.

In any of the various embodiments discussed herein, the lever system is coupled to the gas cylinder coupling assembly by a cam such that the gas cylinder coupling assembly moves vertically up in response to the lever moving from the closed position to the open position and the filter coupling assembly moves vertically down in response to the lever moving from the open position to the closed position.

In any of the various embodiments discussed herein, the gas cylinder mount includes a first C-shaped rim extending perpendicular out from the wall; and a second C-shaped rim below the first C-shaped rim, the second C-shaped rim extending perpendicular out from the wall. In any of the various embodiments discussed herein, the slot is defined by the space between the first surface and the second surface.

In any of the various embodiments discussed herein, a height of the slot at the front of the slot is greater than a height of the slot at the back of the slot.

In any of the various embodiments discussed herein, the gas cylinder mount includes a first O-ring disposed in the receptacle, and a second O-ring disposed in the receptacle below the first O-ring and spaced apart from the first O-ring.

In any of the various embodiments discussed herein, the gas cylinder mount includes the gas cylinder. In any of the various embodiments discussed herein, the gas cylinder comprises a pin configured to be depressed to open a valve of the gas cylinder. In any of the various embodiments discussed herein, the gas cylinder coupling assembly is configured to depress the pin as the gas coupling assembly moves from the locked position to the sealed position.

In any of the various embodiments discussed herein, the gas cylinder includes an outlet disposed on a side of the head of the gas cylinder, wherein the opening aligns with the space between the first O-ring and the second O-ring.

In any of the various embodiments discussed herein, the regulator includes a gas inlet aligned with the space between the first O-ring and the second O-ring such that a flow path is formed from an interior of the gas cylinder, through gas cylinder outlet, through the space between the first O-ring and the second O-ring, and into the gas inlet of the regulator.

In any of the various embodiments discussed herein, the gas cylinder comprises a flange disposed around the head of the gas cylinder, wherein the slot is configured to receive the flange.

In any of the various embodiments discussed herein, the gas cylinder coupling assembly is in fluid communication with a carbonator.

In any of the various embodiments discussed herein, the gas cylinder comprises a valve configured to remain open when the lever is in the closed position.

Some embodiments are directed to an ingredient cartridge mount that includes a receptacle comprising a recess configured to receive a base of the ingredient cartridge; a bottle press assembly; and a lever system. The bottle press assembly can include a hose configured to be removably and fluidly coupled to the ingredient cartridge. The bottle press assembly can be configured to secure the ingredient cartridge to the ingredient cartridge mount. The bottle press assembly can be configured to be moved between a sealed position and an unsealed position, be sealingly coupled to the ingredient cartridge in the sealed position, and be not coupled to the ingredient cartridge in the unsealed position.

In any of the various embodiments discussed herein, the lever system coupled to the bottle press assembly and can include a lever configured to move between a closed position and an open position. In any of the various embodiments discussed herein, the bottle press assembly is configured to move from the unsealed position to the sealed position in response to the lever moving from the open position to the closed position.

In any of the various embodiments discussed herein, the lever is rotatable about an axis, and wherein the bottle press is movable vertically between the sealed position and the unsealed position.

In any of the various embodiments discussed herein, the open position is about 90 degrees relative to the closed position.

In any of the various embodiments discussed herein, the lever system is coupled to the bottle press assembly by a cam such that the bottle press assembly moves vertically up in response to the lever moving from the closed position to the open position and the bottle press assembly moves vertically down in response to the lever moving from the open position to the closed position.

In any of the various embodiments discussed herein, the hose comprises a first end configured to fluidly couple to the ingredient cartridge, wherein the hose narrows at the first end.

In any of the various embodiments discussed herein, the hose comprises a second end in fluid communication with a pump configured to pump ingredients from the ingredient cartridge.

In any of the various embodiments discussed herein, the pump is in fluid communication with a nozzle of the beverage dispenser, and after extracting ingredient from the ingredient cartridge, the pump is configured to reverse pumping direction to retract ingredients between the pump and the nozzle.

In any of the various embodiments discussed herein, the ingredient cartridge, the pump is configured to reverse pumping direction to retract ingredients between the pump and the nozzle.

Some embodiments are directed to an ingredient dosing system for a beverage dispensing system, that includes a first ingredient cartridge mount a second ingredient cartridge mount, a first pump, and a second pump. The first ingredient cartridge mount can be the ingredient cartridge mount according to any of the various embodiments discussed herein. The second ingredient cartridge mount can be disposed horizontally next to the first ingredient cartridge mount. The first ingredient cartridge can be coupled to the first ingredient cartridge mount. The second ingredient cartridge can be coupled to the second ingredient cartridge mount. The first pump fluidly can be coupled to the first ingredient cartridge mount and in fluid communication with a nozzle of the beverage dispensing system. The first pump can be configured to pump ingredients from the first ingredient cartridge. The second pump can be fluidly coupled to the second ingredient cartridge mount and in fluid communication with the nozzle of the beverage dispensing system. The second pump can be configured to pump ingredient from the second ingredient cartridge.

In any of the various embodiments discussed herein, the first pump is in fluid communication with the first ingredient cartridge mount and the nozzle.

In any of the various embodiments discussed herein, the second pump is in fluid communication with the second ingredient cartridge mount and the nozzle.

In any of the various embodiments discussed herein, the first pump and the second pump are independently operable.

In any of the various embodiments discussed herein, the ingredient dosing system includes a third ingredient cartridge mount disposed vertically below the first ingredient cartridge mount; a third ingredient cartridge coupled to the third ingredient cartridge mount; and a third pump fluidly coupled to the first ingredient cartridge mount and in fluid communication with a nozzle of the beverage dispensing system, the third pump configured to extract ingredients from the third ingredient cartridge.

Some embodiments are directed to an ingredient cartridge for a beverage dispenser that includes a body, an interior volume, and a closure. The body can include sidewalls, a base, a neck portion, and an interior volume defined in part by the side walls, the interior volume configured to store an ingredient. The closure can include a sidewall; a top portion that includes an upper surface; a lower surface opposite the upper surface; a first opening configured to receive a hose, and a second opening. The closure can include a straw coupled to the lower surface of the top portion at the opening to create a flow path into cartridge, the straw extending down into the interior volume; and a membrane coupled to the lower surface of the top portion, wherein the membrane is a one-way vent configured to allow air flow into the interior volume as ingredients are removed from the interior volume.

In any of the various embodiments discussed herein, the membrane seals the second opening such that liquid cannot exit ingredient cartridge at the second opening. In any of the various embodiments discussed herein, the ingredient cartridge is configured to receive the hose at the first opening such that the ingredient cartridge is fluidly coupled to the beverage dispenser.

In any of the various embodiments discussed herein, the ingredient cartridge is configured to be removably and fluidly coupled to a pump, wherein the pump is configured to extract the ingredient from the interior volume.

In any of the various embodiments discussed herein, the ingredient cartridge includes a rim disposed on the upper surface of the top portion and surrounding the first opening and the second opening.

In any of the various embodiments discussed herein, the ingredient cartridge includes a seal removably coupled to the upper surface of the top portion, and the seal is configured to seal the first opening and the second opening.

In any of the various embodiments discussed herein, the seal comprises foil.

In any of the various embodiments discussed herein, The ingredient cartridge includes the ingredient disposed in the interior volume.

In any of the various embodiments discussed herein, the closure comprises threads on an internal surface of the sidewalls, and wherein the neck portion comprises threads on an external surface.

In any of the various embodiments discussed herein, the straw is integral with the top portion of the closure.

Some embodiments are directed to a beverage dispenser system that includes a water filter cartridge mount configured to receive a water filter cartridge; a gas cylinder cartridge mount configured to receive a gas cylinder; an ingredient cartridge mount configured to receive an ingredient cartridge; and an electronics system comprising sensors configured to detect performance of the beverage dispenser.

In any of the various embodiments discussed herein, the electronics system is configured to communicate with a remote device, wherein the electronics system is configured to provide data to the remote device, wherein the data is related to at least one of the water filter cartridge, the gas cylinder, or the ingredient cartridge.

In any of the various embodiments discussed herein, the remote device is an artificial intelligence machine configured to provide feedback to the electronics system.

In any of the various embodiments discussed herein, the electronics system is configured to adjust at least one parameters based on the feedback from the artificial intelligence machine.

In any of the various embodiments discussed herein, the gas cylinders, ingredient cartridges, filter cartridges, and other components of the beverage dispenser can include an identifier tag (e.g., an RFID or a QR code) so that only authorized and non-counterfeit OEM components can be used.

In any of the various embodiments described herein, the gas cylinders, ingredient cartridges, filter cartridges, and other components can be reused or recycled.

In any of the various embodiments described herein, the system components can be disassembled so that they are reused or recycled.

### BRIEF DESCRIPTION OF THE FIGURES

FIG. 1 illustrates a perspective view of a beverage dispensing system according to some embodiments.

FIG. 2 illustrates a diagram of components of a beverage dispensing system according to some embodiments.

FIG. 3 illustrates an electronics system of a beverage dispensing system according to some embodiments.

FIG. 4 illustrates the beverage dispensing system of FIG. 1 with the door open.

FIG. 5 illustrates portions of the ingredient system of the dispenser shown in FIG. 1.

FIG. 6 illustrates an ingredient cartridge used with the ingredient system shown in FIG. 5.

FIG. 7A illustrates a cross-section at line 5-5 of the ingredient system shown in FIG. 5 with the lever in the open position.

FIG. 7B illustrates the cross-section of FIG. 7A with the lever in the closed position.

FIG. 8 illustrates portions of the gas system of the dispenser shown in FIG. 1.

FIG. 9 illustrates an exploded view of the lever system of the gas system shown in FIG. 8.

FIG. 10A illustrates a cross-section at line 8-8 of the gas system shown in FIG. 8 with the lever in the open position.

FIG. 10B illustrates the cross-section of FIG. 10A with the lever in the closed position.

FIG. 11 illustrates portions of the filter system of the dispenser shown in FIG. 1.

FIG. 12 illustrates an exploded view of the lever system of the filter system shown in FIG. 11.

FIG. 13 illustrates a perspective view of the lever system of the filter system shown in FIG. 11 with the lever in the open position.

FIG. 14A illustrates a cross-section at line 11-11 of the filter system shown in FIG. 11 with the lever in the open position.

FIG. 14B illustrates the cross-section of FIG. 14A with the lever in the closed position.

FIG. 15 illustrates a filter used in the filter system shown in FIG. 11.

FIG. 16 illustrates a diagram of flow paths between various systems of the dispenser.

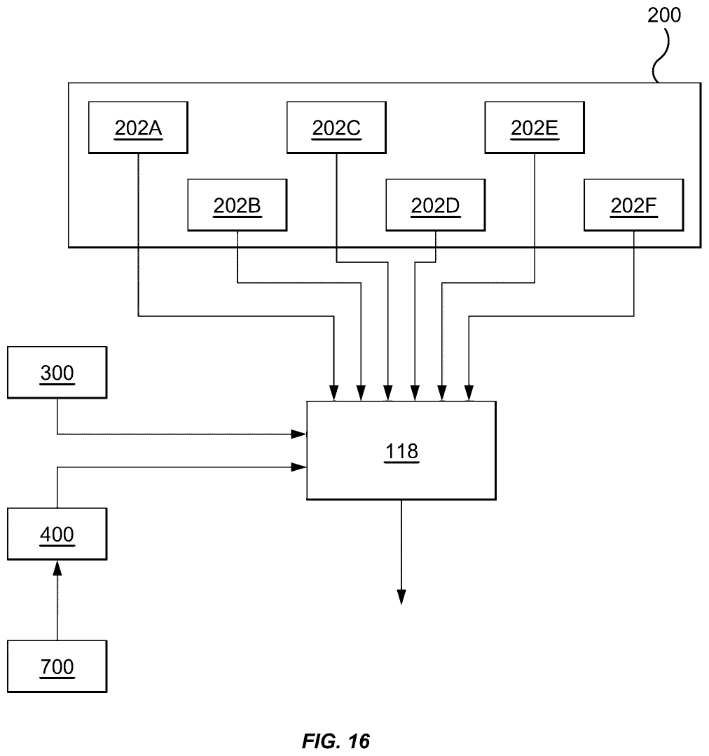

FIG. 17 illustrates a nozzle used with the dispenser shown in FIG. 1.

FIG. 18 illustrates a cross-section at line 17A-17A of the nozzle shown in FIG. 17.

FIG. 19 illustrates a cross-section at line 17B-17B of the nozzle shown in FIG. 17.

FIG. 20 illustrates a fluid diagram of the dispenser according to some embodiments.

FIG. 21A a system for applying machine learning to systems according some embodiments.

FIG. 21B illustrates an analytic structure according to some embodiments.

FIG. 22 illustrates communication systems according to some embodiments.

FIG. 23 illustrates a flowchart for integration of various components of systems according to some embodiments.

FIG. 24 illustrates a flowchart for integration of various systems according to some embodiments.

FIG. 25A illustrates a diagram of electronics systems on systems according to some embodiments.

FIG. 25B illustrates a diagram of electronics systems on systems according to some embodiments.

### DETAILED DESCRIPTION

Countertop beverage dispensers provide convenient access to customizable beverages made on-demand. Such dispensers often include various consumables, such as gas (e.g., carbon dioxide), a filter, and flavors. Existing systems often require special tools, specialized technicians, and/or training to replace these consumables. Further, existing systems often place the consumables on the side of the device, behind a side door, making them difficult to access without moving or rotating the device to access the side.

Further, existing systems often couple consumables in ways that require precision, specific orientations, and/or tools. For example, existing systems often use screw attachments to secure the consumable in the device. This presents challenges because it can be difficult to align the threaded portion of the consumable with the threads in the device. Such screw attachments require relatively precise coupling. For example, if the screw is not screwed tight enough, the consumable can leak during use. But if the screw is screwed too tight, the consumable can be overtightened and leak and/or make it challenging to remove later on. Additionally, existing system often require that the consumable be inserted in specific orientation and/or direction (e.g., the consumable has a “front” and “back”) such that the consumable will not couple to the system if it is not inserted in the specific orientation and/or direction.

In addition, existing systems are often larger and take up more space, for example, on the countertop and in storage areas. Often this this is because existing systems place the consumables in a different room, under the counter, or in other more inconvenient locations. Existing systems also may require complex instillation steps such as drilling a hole in the countertop and/or connecting to consumables in other rooms or other difficult to reach locations (e.g., under the counter). This limits the places where existing systems can be used. Despite the small footprint, embodiments disclosed herein are capable of delivering a large variety of options in a safer, more sanitary, efficient, and user friendly manner with a greater degree of user customization. For example, unlike the complicated installation steps associated with existing systems, embodiments described herein may only require a connection to a water line. In some embodiments, a flexible pipe can connect the system to a water line. Indeed, system described herein may be installed and set up without requiring manual intervention or a specialized technician.

Moreover, existing systems often lack authentication and safety mechanisms that prevent use of unsafe, counterfeit, defective, out of date, expired, and/or unauthorized, components or ingredients are not used. Further, existing systems lack reliable consumption and user tracking capabilities.

Embodiments described herein overcome these and other challenges by providing—among other benefits—a self-contained beverage dispenser system that can dispense carbonated beverages, still beverages, hot beverages, flavored beverages, among others. Moreover, unlike existing systems, embodiments described herein may be set up and maintained by the user without special training, tools, or technical expertise. For example, all beverage components (e.g., water, carbonation, ingredients, etc.) may be in replaceable cartridges, and those cartridges may be replaced easily without any tools or special training or expertise. Additionally, all consumables can be accessible behind a door on the front of the machine, making them readily accessible by only opening the front door.

Additionally, embodiments described herein allow for different types of users, as determined by various types of authentication. For example, one type of user can have maintenance or administrative privileges. Or, as another example, users can be differentiated based on products and/or features they are allowed to access, amounts charged for consumables, or the quantity of consumables that can be served over a period of time

Moreover, embodiments described herein provide a self-contained, above-the-counter beverage dispenser that allows for personalization of flavor intensity, temperature, and carbonation levels. The system can have a small form factor, as described below.

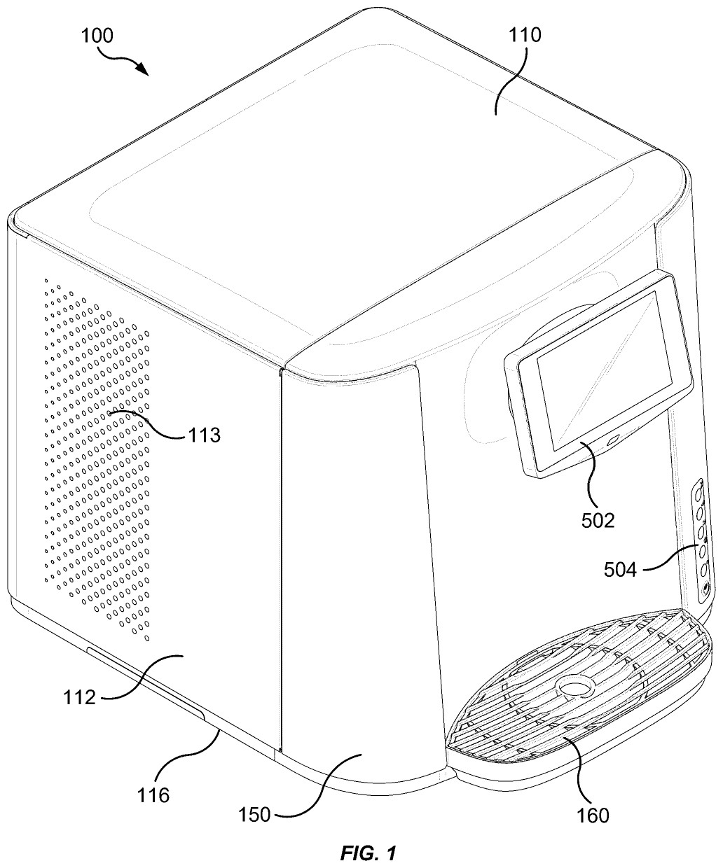

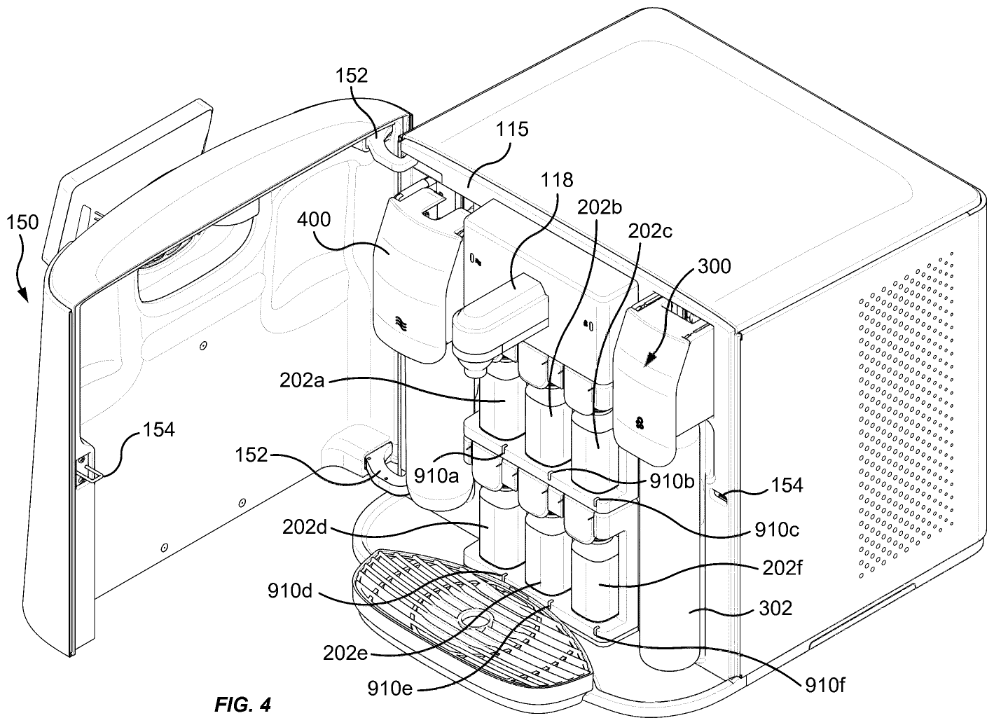

Dispenser systems disclosed herein (e.g., system 100) may include various components for making a beverage in a self-contained unit, as shown in FIG. 1. As shown in FIG. 1, system 100 can include a housing defined in part by top wall 110, side walls 112, base 116, and door 150. System 100 can also include one or more user interfaces 500 (e.g., display 502 and/or buttons 504). In some embodiments, as shown in FIG. 4, door 150 includes hinges 152 for opening and closing door 150. In some embodiments, door 150 is tensioned to prevent door 150 from swinging too far open. Door 150 can include a latch (e.g., latch 154) to secure door 150 in the closed position. In some embodiments, latch 154 includes a lock (e.g., lock 906). In some embodiments, the lock is unlocked in response to a user input, for example on display 502 and/or buttons 504. In some embodiments, buttons 504 can control all functionality of system 100. In some embodiment, buttons 504 are ADA compliant. In some embodiments, control unit 902 is configured to unlock the lock. In some embodiments, door 150 can be opened only by an authorized user (e.g., as detected by electronics system 900).

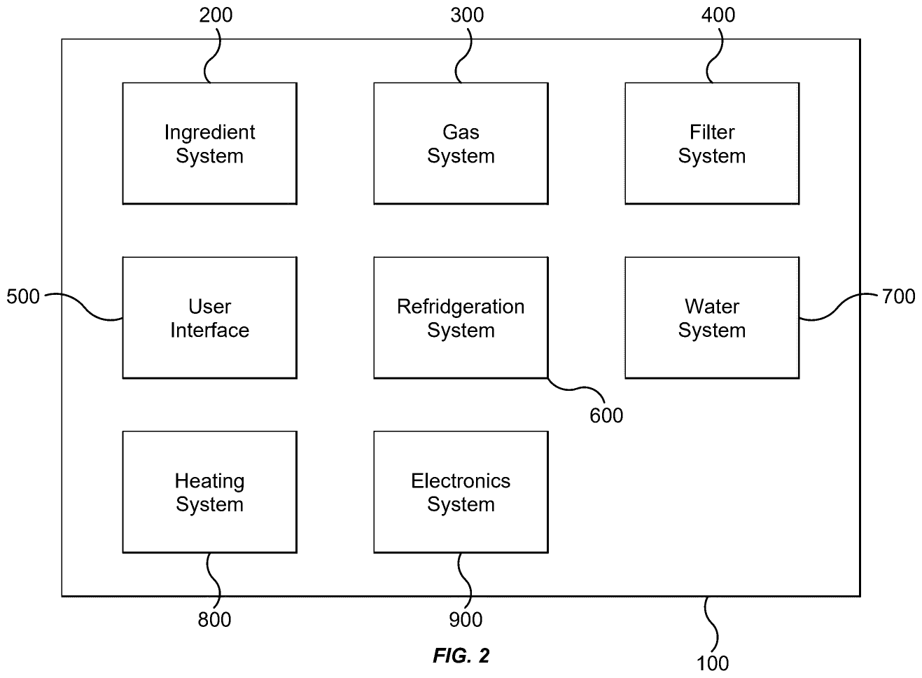

In some embodiments, as shown in FIG. 2, system 100 includes ingredient system 200, gas system 300, filter system 400, user interface 500, refrigeration and carbonation system 600, heating system 800, and electronics system 900. System 100 may be a self-contained device for dispensing a beverage. Consumable components can be used with system 100 to make a beverage. In some embodiments, the consumable components include ingredient cartridge(s) 202, gas cylinder 301, and filter cartridge 402. In some embodiments, each of the consumable components is replaceable. In some embodiments, each of the consumable components is coupled to a forward-facing wall (e.g., wall 115) of the housing of system 100. In some embodiments, wall 115 is exposed when door 150 is opened. In some embodiments, all consumable components are replaceable. This arrangement offers easy access for an end user to replace the consumable without special tools and/or training.

In some embodiments, the beverage is a carbonated and/or a flavored beverage. In some embodiments, the beverage is a still and/or flavored beverage. System 100 can be configured to receive various consumables, such as ingredients (e.g., ingredient cartridges 202), a gas cylinder (e.g., gas cylinder 301), and a filter (e.g., filter cartridge 402).

System 100 may have a compact and self-contained design such that system 100 can sit on a countertop, or be attached to a stand (e.g., a pedestal). For example, system 100 may have a width of from about 12 inches to about 36 inches (e.g., from about 18 inches to about 24 inches). In some embodiments, system 100 may have a depth from about 12 inches to about 24 inches (e.g. from about 18 inches to about 24 inches). In some embodiments, system 100 may have a height from about 12 inches to about 24 inches (e.g., from about 15 inches to about 18 inches). In some embodiments, system 100 has a width of less than about 24 inches, a depth of less than about 24 inches, and a height of less than about 18 inches).

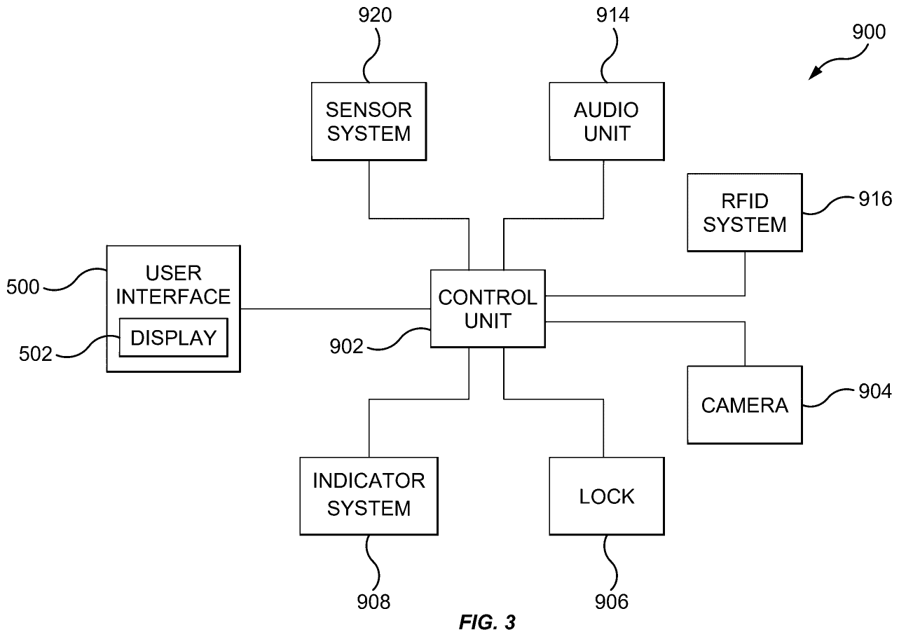

System 100 can include electronics system 900, as shown in FIG. 3, for controlling operation of system 100, monitoring the various systems within system 100, receiving user input, alerting the user to the status of various systems, etc. In some embodiments, electronics system 900 can include control unit 902, camera 904, lock 906, indicator system 908, user interface 500, audio unit 914, identifier system 916, and sensor system 920.

Indicator system 908, identifier system 916, and sensor system 920 are discussed in more detail below.

System 100 can include ingredient system 200 for providing ingredients, for example, from ingredient cartridges 202. Ingredient system 200 can include a mounting system for securing ingredient cartridges 202 to ingredient system 200. As shown in FIG. 4 system 100 can include numerous ingredient cartridges 202 that are easily accessible when door 150 is opened. Ingredients may include various things. For example, when used for making a beverage, ingredients may include syrups, flavors, vitamins, electrolytes, energy boosters, minerals, or combinations thereof. When used for cleaning or maintaining system 100, ingredients may include cleaners, sanitizing materials, flushing materials, etc.

System 100 can include 1 or more (e.g., 2 or more, 3 or more, 4 or more, 5 or more, 6 or more, 7 or more, 8 or more, 9 or more, 10 or more, 11 or more, or 12 or more, 15 or more, 18 or more, or 20 or more) ingredient cartridge slots 221 for receiving ingredient cartridges 202. In some embodiments, system 100 includes 3 ingredient cartridge slots 221. In some embodiments, system 100 includes 6 ingredient cartridge slots 221, as shown in FIG. 4. In some embodiments, system 100 includes 6 to 12 ingredient cartridge slots 221.

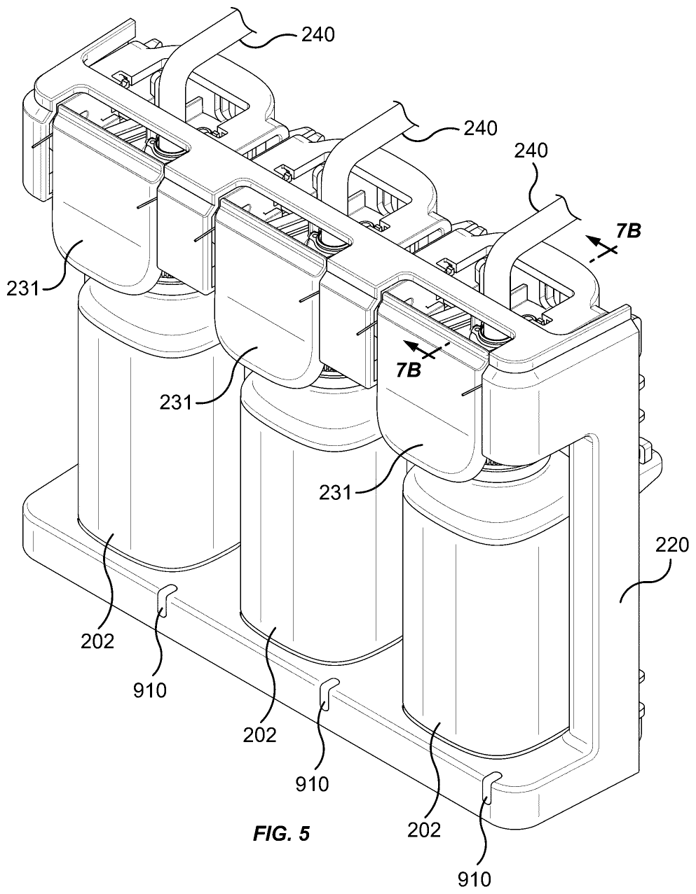

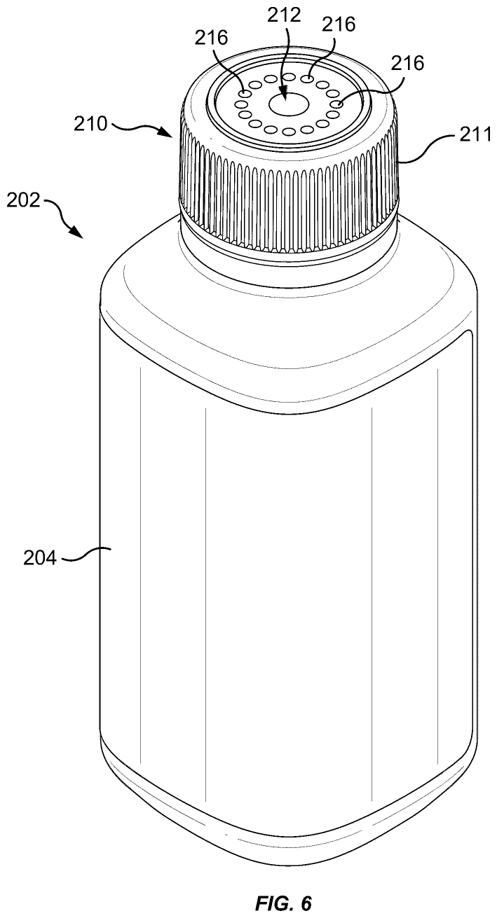

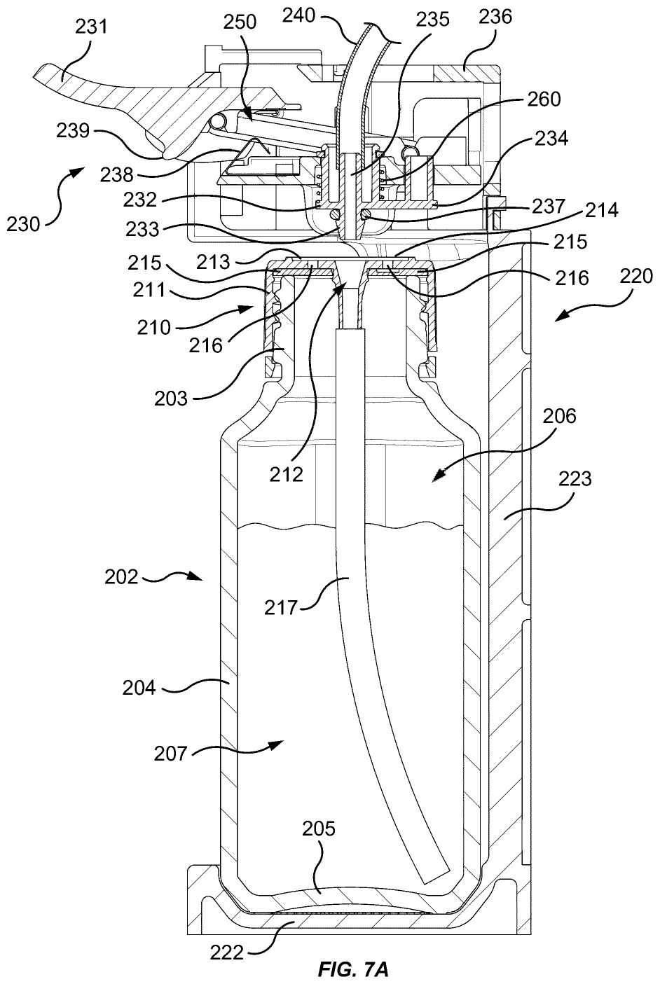

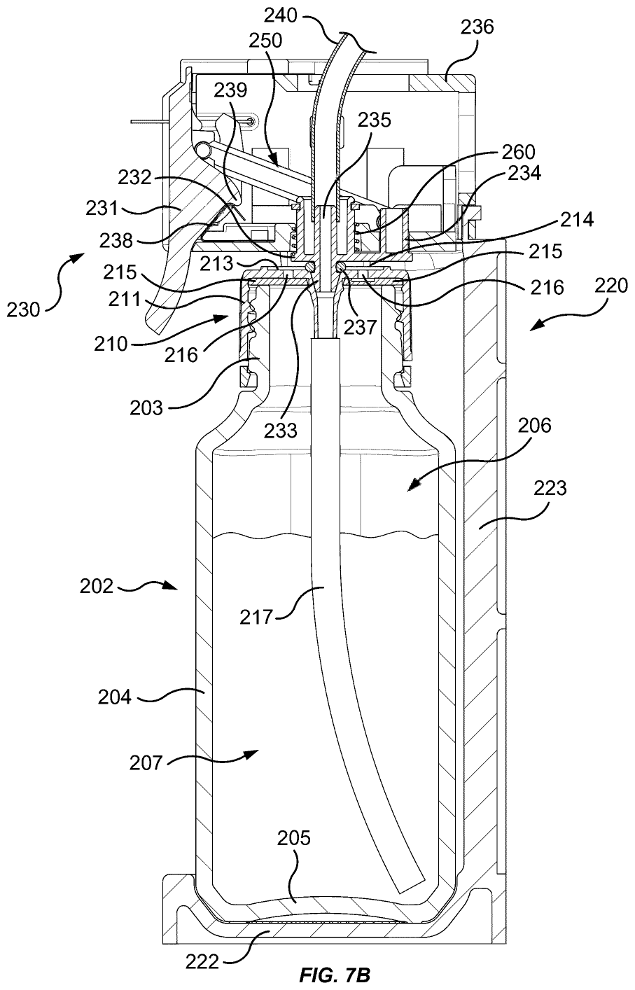

As shown in FIG. 5, ingredient system 200 can include frame 220, lever system 230, and hoses 240. In some embodiments, ingredient system 200 includes at least 1 ingredient cartridge 202. In some embodiments, ingredient system 200 includes an ingredient cartridge 202 in each ingredient cartridge slot 221. Each of these is described in more detail below with reference to FIGS. 6, 7A, and 7B.

FIG. 6 illustrates an ingredient cartridge 202. A cross-section of ingredient cartridge 202 is shown in FIG. 7A. As shown in FIGS. 6 and 7A, ingredient cartridge 202 can include neck portion 203, sidewalls 204, and base 205 that define internal volume 206 of ingredient cartridge 202.

Ingredient cartridge 202 can include a closure (e.g., closure 210) and a tamper-evident seal (e.g., collar 218), as shown in FIGS. 6 and 7A. Closure 210 can include sidewalls 211 and top 213. In some embodiments, closure 210 can be screwed onto neck portion 203. For example, sidewalls 211 can include threads that interact with threads of neck portion 203. In some embodiments, sidewalls 211 include internal threads that interact with external threads of neck portion 203, as shown in FIGS. 7A and 7B. Closure 210 can also include seal 214, membrane 215, and holes 216.

In some embodiments, seal 214 seals ingredient cartridges 202, for example by covering holes 216. In some embodiments, seal 214 is a foil. In some embodiments, seal 214 is a plastic material. In some embodiments, seal 214 is removed prior to using ingredient cartridge 202. In some embodiments, seal 214 remains on ingredient cartridge 202 during use and is opened, for example, by bottle press 232. In some embodiments, bottle press 232 can include one or more spikes that pierce seal 214. Seal 214 helps prevent contamination, for example, during transportation.

In some embodiments, neck portion 203, sidewalls 204, and base 205 are made of a rigid material (e.g., glass, metal, composite, and/or a rigid plastic). As ingredients are dispensed from ingredient cartridge 202, negative pressure builds in internal volume 206. If too much negative pressure builds, sidewalls 204 may collapse or the pump will not be strong enough to extract ingredients from ingredient cartridge 202 after the negative pressure reaches a certain level. To compensate for the negative pressure and to allow air to enter ingredient cartridge 202, closure 210 may include membrane 215 and openings 216. In some embodiments, membrane 215 is a one-way vent. In some embodiments, membrane 215 permits air to flow only in one direction, for example into internal volume 206 of ingredient cartridge 202. This allows for ingredient cartridge 202 to compensate for increases in negative pressure as the ingredients in ingredient cartridge 202 are dispensed. In some embodiments, membrane 215 is hydrorepellant. Often ingredient cartridge 202 can be turned upside down prior to use, for example during shipping. A hydrorepellant membrane can prevent ingredients from leaking out of ingredient cartridge 202 prior to use (e.g., during shipping, selling, etc.). For example, In some embodiments, membrane 215 is made of polyethylene. In some embodiments, membrane 215 is a foam. In some embodiments, membrane 215 includes a polyethylene foam, a low-density polyethylene (LDPE), an expanded polyethylene (EPE), or combinations thereof.

In some embodiments, closure 210 includes opening 212. In some embodiments, opening 212 is configured to receive pin 233 of bottle press 232. In some embodiments, as shown in FIG. 7A, opening 212 narrows from top to bottom and has a shape that corresponds to a shape of pin 233 of bottle press 232. For example, in some embodiments, pin 233 has its outer surface conic shaped to ensure perfect sealing with opening 212 when bottle press 232 is lowered with a certain force over the surface 213 of closure 210. This allows for pin 233 to contact opening 212 and create a seal with closure 210. In some embodiments, pin 233 contacts opening 212 to create a watertight seal with closure 210. In some embodiments, bottle press 232 includes gasket 237 for ensuring a seal between pin 233 and closure 210. In some embodiments, gasket 237 is an O-ring.

Ingredient cartridge 202 can include straw 217, which can be used to draw ingredients out of ingredient cartridge 202. In some embodiments, straw 217 is coupled to closure 210, for example, at opening 212. In some embodiments, straw 217 is removably coupled to closure 210. In some embodiments, straw 217 is integral with straw 217, for example as shown in FIGS. 7A and 7B. Straw 217 may be made of a flexible material. As shown in FIG. 7A, straw 217 can be longer than a height of internal volume 206 such that straw is curved. This curve allows the straw to be positioned proximate to the lowest portion of internal volume 206 on base 205. Straw 217 may be made in the same plastic material of closure 210 or in a different material, such as silicone.

Ingredient cartridge 202 can include an identifier coupled to an exterior of ingredient cartridge 202. As used herein, an identifier tag can include and RFID tag, QR code readers, barcode readers, NFC, NB-IoT, ultrasound waves, GPS, or combinations thereof. In some embodiments, the identifier tag can be used for authentication to ensure that only authorized ingredient cartridges are used. In some embodiments, system 100 can be deactivated and/or provide a warning message to the user if counterfeit, unauthorized, defective, or expired ingredient cartridges are inserted into system 100. In some embodiments, the ingredient cartridge 202's identifier tag is an RFID tag. As described in more detail below related to the electronics system, the identifier tag on ingredient cartridge 202 allows system 100 to track, among other things, the ingredients in the ingredient cartridges 202, the shelf-life of the ingredients, its production batch, expiration date, and the amount of ingredient left in ingredient cartridges 202. In some embodiments, the identifier tag can be embedded in a label affixed to an outer surface of ingredient cartridge 202.

Ingredient system 200 can include lever system 230 for securing ingredient cartridge 202 in system 100. FIG. 7A shows a cross-section along line 5-5 with lever system 230 in the open position, and FIG. 7B shows a cross-section along line 5-5 with lever system 230 in the closed position. Lever system 230 can include various components, such as lever 231, bottle press 232. Lever system 230 can be configured to raise and lower bottle press 232 in response to lever 231 moving between an open position (e.g., as shown in FIG. 7A) and a closed position (e.g., as shown in FIGS. 5 and 7B). In some embodiments when lever 231 is moved from the open position to the closed position, bottle press 232 moves down to couple to ingredient cartridge 202. As shown in FIG. 7B, when lever 231 is in the closed position, pin 233 of bottle press 232 is inserted into opening 212 of closure 210. Further, as shown in FIGS. 7A and 7B, bottle press 232 includes spring 260. Spring 260 can compress as bottle press 232 is lowered. This can allow bottle press 232 to accommodate ingredient cartridges having different heights. For example, glass can have a high manufacturing tolerance such that each ingredient cartridge 202 may vary slightly in height (e.g., by ±1 mm). In some embodiments, spring 260 surrounds at least a portion of bottle press 232.

In some embodiments, when lever 231 is moved from the closed position to the open position, bottle press 232 moves up to separate from ingredient cartridge 202. In some embodiments, when lever 231 is in the closed position, ingredient cartridge 202 is secured in ingredient system 200 such that it cannot be removed. In some embodiments, ingredient cartridge 202 is removable only when lever 231 is in the open position. In some embodiments, lever system 230 include a cam system for moving bottle press 232 up and down in response to lever 231 being moved between the open position and the closed position. In some embodiments, lever 231 can include protrusion 239 that can interact with spring 238. In some embodiments, spring 238 is a variable spring. For example, spring 238 can be pushed down by lever 231 so that protrusion 239 can pass over spring 238. This prevents lever 231 from being unintentionally opened. Spring 238 can keeping lever 231 completely opened such that bottle press 232 is positioned to its maximum upside position thus allowing an easy insertion and removal of the ingredient cartridge 202 into its slot 221.

The lever system 230 allows ingredient cartridges to be easily replaceable. For example, to replace an ingredient cartridge, a user need only open lever 231, remove ingredient cartridge 202, insert a new ingredient cartridge 202 into ingredient cartridge slot 221 of frame 220, and close lever 231.

In some embodiments, when lever 231 is in the closed position, internal volume 206 of ingredient cartridge 202 is fluidly coupled to beverage system 100. For example, as shown in FIG. 7B, when lever 231 is closed, a fluid flow path is formed from internal volume 206 and through straw 217, opening 212, tube 235 of bottle press 232, and hose 240. In some embodiments, the flow path is uninterrupted from internal volume 206 to hose 240 In some embodiments, hose 240 is coupled to bottle press 232 by interference fit.

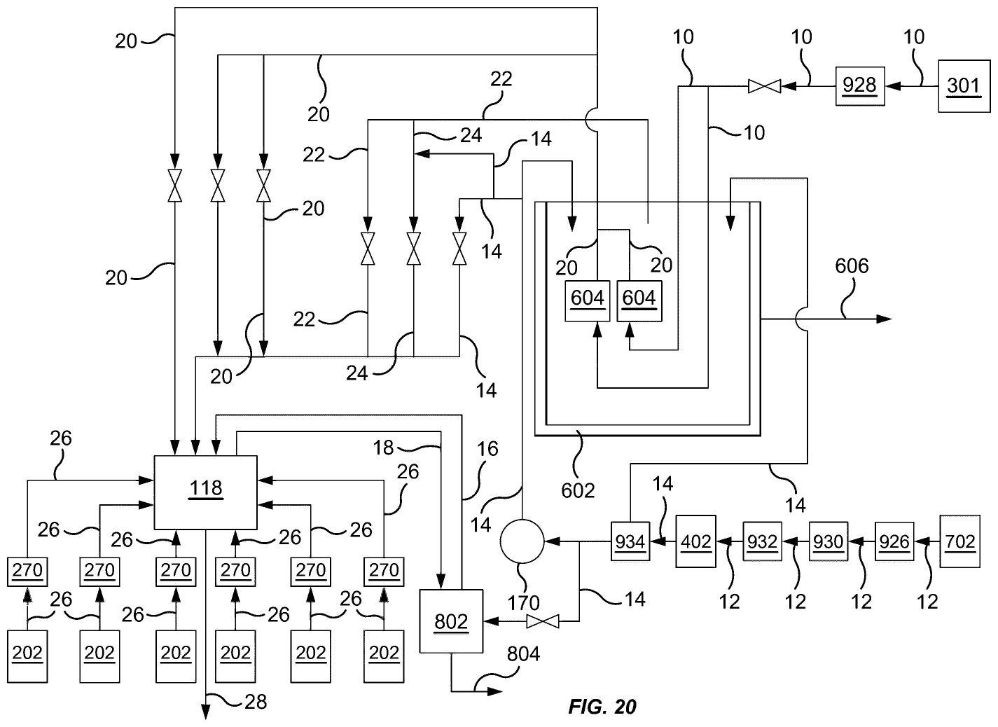

In some embodiments, ingredient system 200 includes at least one pump (e.g., pump 270) for pumping ingredients (e.g., ingredient 207) out of ingredient cartridge 202. In some embodiments, ingredient system can include 1 or more (e.g., 2 or more, 3 or more, 4 or more, 5 or more, 6 or more, 7 or more, 8 or more, 9 or more, 10 or more, 11 or more, or 12 or more, 15 or more, or 20 or more) pumps 270 for pumping ingredients from ingredient cartridges 202. In some embodiments, system 100 includes 3 pumps 270. In some embodiments, system 100 includes 6 pumps 270, as shown in FIG. 20. In some embodiments, system 100 includes 6 to 12 pumps 270.

Each ingredient cartridge 202 can be fluidly coupled to one pump 270. In some embodiments, each pump 270 is fluidly coupled with only one ingredient cartridge, for example, when lever 231 is in the closed position. As shown in FIG. 20, each ingredient cartridge is fluidly coupled to a dedicated pump 270. Each pump may be operated independently of the others. In some embodiments, each pump 270 is controlled by control unit 902. For example, in some embodiments, each pump 270 can operate at different rates to pump different amounts of each ingredient. This allows a user to mix different ingredients in different amounts.

In some embodiments, pump 270 is a positive displacement pump (e.g., a peristaltic pump, a diaphragm pump, or a piston pump). In some embodiments, pump 270 is a peristaltic pump. In some embodiments, system 100 includes more than one pump 270, and each pump 270 is a peristaltic pump.

Ingredient 207 in ingredient cartridge 202 can be a concentrated ingredient that is mixed with water to dilute the concentrated ingredient to create a beverage. In some embodiments, the concentrated ingredient has a dilution factor from about 300:1 to about 19:1. In some embodiments, the dilution factor is from about 400:1 to about 19:1, from about 350:1 to about 20:1, from about 295:1 to about 30:1, 250:1 to about 50:1, from about 200:1 to about 75:1, from about 150:1 to about 100:10, or within a range having any two of these values as endpoints. In some embodiments, the dilution factor is from about 100:1 to about 30:1. In some embodiments, the dilution factor is about 295:1. In some embodiments, the dilution factor is about 30:1.

In some embodiments, ingredients can be dosed (i.e., provided to the nozzle for mixing) based on the ingredients' specific dilution factor and the user's desired flavor intensity. For example, in some embodiments, a user can select a desired flavor intensity using user interface 500. In some embodiments, a user can select a “light,” “medium”, or “strong” flavor. In some embodiments, the ingredients are dosed based on the dilution factor to achieve the “medium” flavor. In some embodiments, to achieve the light flavor, the ingredient is dosed at 80% of the amount of flavor dosed to achieve medium flavor. In some embodiments, to achieve the strong flavor, the ingredient is dosed at 120% of the amount of flavor dosed to achieve medium flavor. In some embodiments the “medium” dilution factor can be automatically set based on the identifier tag's recognition of the ingredients in ingredient cartridge 202 and the type of water mixed at the nozzle (i.e., carbonated or still). This can be used to match the tasting profile of a commercialized branded beverage. In some embodiments, the dosing can be personalized based on the user, a user's preferences, and/or information provided by the artificial intelligence and/or machine learning described below.

In some embodiments, rate at which pump 270 pumps ingredient 207 can vary depending on the dilution factor of the ingredient disposed in ingredient cartridge 202, and on the desired flavor as described above. As described in more detail below, system 100 can include electronics system 900 that includes control unit 902 and identifier system 916. In some embodiments, identifier system 916 can include an RFID system (e.g., an RFID reader that can read an RFID tag), QR code readers, barcode readers, NFC, NB-IoT, GPS, or combinations thereof. In some embodiments, system 916 includes an RFID system disposed on ingredient cartridge 202 to determine various information (e.g., the dilution factor) of the specific ingredient 207 disposed in ingredient cartridge 202. In some embodiments, control unit 902 changes the rate at which pump 270 pumps ingredient 207 based on the dilution factor read by the identifier system. For example, pump 270 may operate at a lower rate for ingredients that are more highly concentrated and at a higher rate for ingredients that are less highly concentrated.

Ingredient system can include dedicated lines from each ingredient cartridge 202 to nozzle 118. The ingredient(s) can be mixed with water (e.g., still water or carbonated water) at nozzle 118. For example, as illustrated by the diagram in FIG. 20, ingredient 207 in each ingredient cartridge 202 can flow from ingredient cartridge 202 through hose 240 and pump 270 without mixing with any other ingredient lines. This allows ingredient system 200 to pump multiple ingredients simultaneously.

Often a challenge with beverage systems is that water or ingredients can remain in the ingredient lines after a beverage is prepared. In systems with multiple ingredients this can result in unintended mixing of different ingredients during preparation of subsequent beverages. System 100 overcomes this issue by retracting ingredient 207 that remains in hose 240 between pump 270 and nozzle 118. For example, in some embodiments, after a beverage is prepared, each pump 270 that pumped an ingredient 207 can reverse to retract any ingredient 207 remaining in hose 240 between pump 270 and nozzle 118. In some embodiments, a pump 270 is a peristaltic pump that turns backwards, for example, 45 degrees, to retract remaining ingredient 207. After ingredient 207 is dispensed, ingredient system 200 can retract ingredient 207 remaining in hose 240. This prevent unintended mixing of ingredients and cross-contamination of during preparation of later beverages.

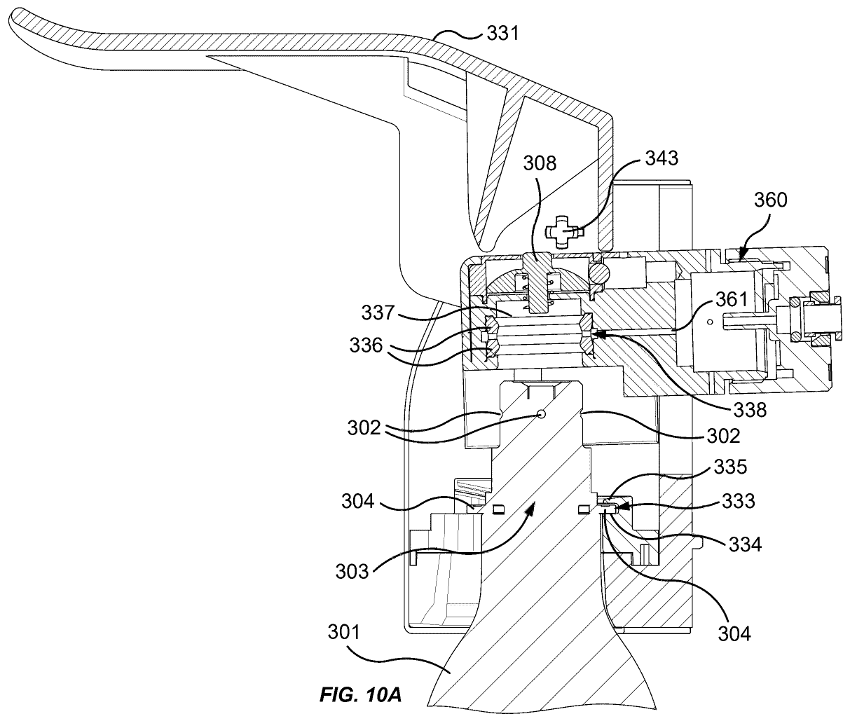

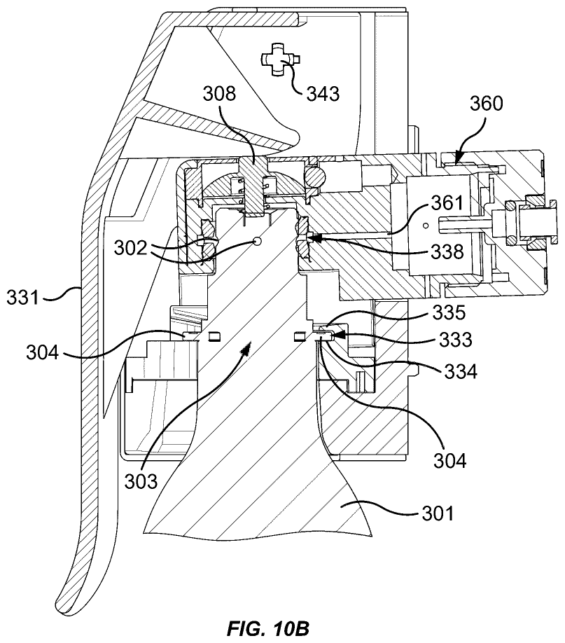

System 100 can include a gas system (e.g., gas system 300) for providing gas (e.g., carbon dioxide) for carbonating water. For example, gas system 300 can include a mounting system for securing gas cylinder 301 to gas system 300. In some embodiments, gas system 300 can include gas cylinder 301 that contains pressurized gas. In some embodiments, gas cylinder 301 is gas cylinder 301 shown, for example, in FIGS. 10, 11, 13, and 14 of U.S. Patent Pub. 2023/0373774, which is incorporated herein by reference.

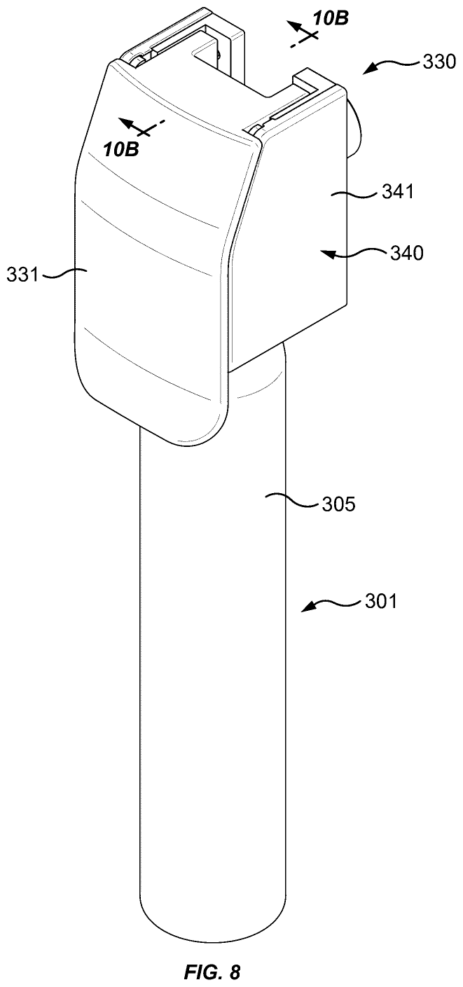

Gas system 300 can include gas cylinder 301, lever system 330, and regulator 360. In some embodiments, gas cylinder 301 is replaceable. FIG. 8 illustrates lever system 330 with gas cylinder 301 coupled to lever system 330. In some embodiments, as shown in FIG. 8, lever system 330 can include lever system housing 340 that receives at least a portion of gas cylinder 301. In some embodiments, gas cylinder 301 includes gas cylinder head 303 and cylinder body 305. Gas cylinder head 303 can include a valve and can couple to lever system 330, for example by flange 304.

Gas cylinder 301 can include pressured gas (e.g., carbon dioxide) disposed in an interior volume of gas cylinder 301. In some embodiments, the gas is pressurized to at least 800 PSI. In some embodiments, the gas is pressurized to from about 800 PSI to about 1200 PSI, from about 800 PSI to about 1200 PSI, from about 1000 PSI to about 2000 PSI, or within a range having any two of these values as endpoints. In some embodiments, the gas is pressurized to about 1000 PSI. Gas system 300 includes regulator 360 that is configured to reduce the pressure of gas exiting gas cylinder 301. This results in a much reduced pressure to carbonate the water before reaching nozzle 118. In some embodiments, gas regulator 360 has a capacity of about 1000 PSI. In some embodiments, regulator 360 reduces the pressure a pressure from about 60 PSI to about 125 PSI, from about 70 PSI to about 110 PSI, from about 80 PSI to about 100 PSI, from about 85 PSI to about 90 PSI, or within a range having any two of these values as endpoints. In some embodiments, regulator 360 reduces the pressure to a pressure from about 100 PSI to about 110 PSI. In some embodiments, gas regulator 360 reduces the pressure to about 100 PSI. In some embodiments, gas regulator 360 reduces the pressure to about 110 PSI.

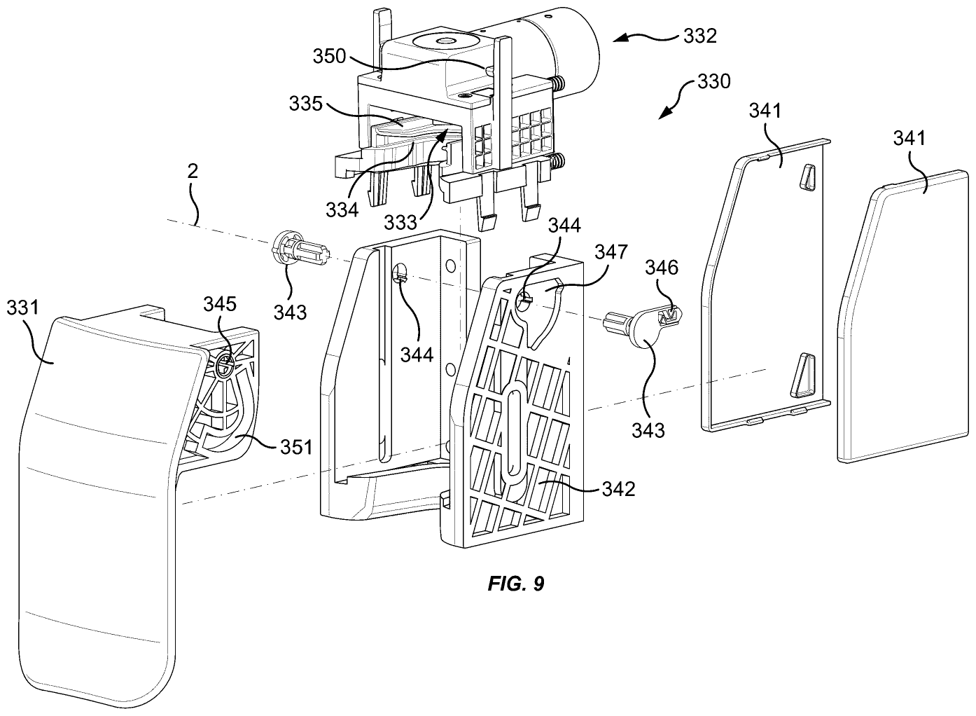

FIG. 9 shows an exploded view of lever system 330. As shown in FIG. 9, lever system 330 can include lever 331, side covers 341, side walls 342, and gas coupling assembly 332. Lever 331 can be rotatably coupled to side walls 342. For example, lever system 330 can include pins 343 that are inserted through holes 344 in side walls 342, as shown in FIG. 9. In some embodiments, opening 345 in a side of lever 331 can receive pin 343 to couple lever 331 to side walls 342. In some embodiments, pin 343 couples to opening 345 by interference fit. In some embodiments, at least one pin 343 includes a head with a protrusion 346, and side wall 342 comprises a recess 347 configured to receive protrusion 346 when pin 343 is inserted in hole 344. In some embodiments, as lever 331 is rotated, protrusion 346 engages with sides of recess 347 to provide an indication of the position of lever 331. In some embodiments, the indication is an audible indication, a tactile indication, or a combination of both.

Gas cylinder 301 one or more gas cylinder outlets 302 disposed around gas cylinder head 303. In some embodiments, gas cylinder outlets 302 are disposed on a sidewall of gas cylinder head 303, as shown in FIGS. 10A and 10B.

Gas system 300 can include lever system 330 for securing gas cylinder 301 in system 100. Lever system 330 can include lever 331 and gas coupling assembly 332 that creates a seal between gas cylinder 301 and regulator 360. Gas coupling assembly 332 can include a receptacle 337 configured to receive gas cylinder head 303.

Gas coupling assembly 332 can include various components that secure gas cylinder 301 in gas system 300. In some embodiments, gas coupling assembly 332 includes slot 333 defined by lower rim 334 and upper rim 335. In some embodiments, a height of slot 333 at the front of the slot is greater than a height of slot 333 at the back of slot 333. In some embodiments, lower rim 334 and upper rim 335 are C-shaped, as shown in FIG. 9. Slot 333 can receive flange 304 of gas cylinder 301. In some embodiments, flange 304 fits tightly into slot 333 to prevent gas cylinder 301 from tilting. Such tilting could break the seal between gas cylinder 301 and regulator 360. In some embodiments, slot 333 includes detents in the side of slot 333 that form an interference fit with gas cylinder 301.

FIG. 10A shows a cross-section along line 8-8 with lever system 330 in the open position, and FIG. 10B shows a cross-section along line 8-8 with lever system 330 in the closed position.

Lever system 330 can be configured to raise and lower gas coupling assembly 332 in response to lever 331 moving between an open position (e.g., as shown in FIG. 10A), and intermediate position, and a closed position (e.g., as shown in FIGS. 8 and 10B). In some embodiments when lever 331 is moved from the open position to the intermediate position, gas coupling assembly 332 moves down such that gas cylinder head 303 is disposed in receptacle 337, but pin 308 is not engaged with the pin of gas cylinder head 303. In some embodiments, when lever 331 is moved from the intermediate position to the closed position, gas coupling assembly 332 moves down to sealingly coupled gas cylinder 301 to gas coupling assembly 332 and engage pin 308. Existing gas cylinders often emit a hissing sound when coupling to a dispensing system, which can be undesirable for the end user. However, lever system 330 disclosed herein eliminates that hissing sound due to the way lever system 330 engages with gas cylinder 301, as described above.

As shown in FIG. 10B, when lever 331 is in the closed position, gas coupling assembly 332 is moved down to a coupling position. For example, when lever 331 is in the closed position, gas coupling assembly 332 can be coupled to gas cylinder head 303. In some embodiments, gas coupling assembly 332 sealingly couples to gas cylinder head 303 to form an airtight seal. In some embodiments, lever 331 is configured to rotate about an axis. In some embodiments, the open position of lever 331 is about 90 degrees relative to closed position of lever 331. In some embodiments, the intermediate position of lever 331 is from about 10 degrees to about 30 degrees relative to closed position of lever 331. In some embodiments, the intermediate position is about 15 degrees relative to the closed position of lever 331.

In some embodiments, when lever 331 is moved from the closed position to the open position, gas coupling assembly 332 moves up to separate from gas cylinder 301. In some embodiments, when lever 331 is in the intermediate position or the closed position, gas cylinder 301 is secured in gas system 300 such that it cannot be removed. In some embodiments, gas cylinder 301 is removable only when lever 331 is in the open position. In some embodiments, lever system 330 includes a cam system for moving fluid coupling 332 up and down in response to lever 331 being moved between the open position, the intermediate position, and the closed position. In some embodiments, lever 331 can include a cam system that moves gas coupling assembly up and down in response to lever 331 being moved between the open position, the intermediate position, and the closed position.

In some embodiments, lever system 330 includes a first cam system and a second cam system. In some embodiments, the first cam system is configured to move gas coupling assembly 332 from the down from a first position (e.g., as shown in FIG. 10A) to a second position (e.g., as shown in FIG. 10B) in which gas cylinder 301 forms an airtight seal with gas coupling assembly 332 but pin 308 is not engaged. In some embodiments, the second cam system is configured to push pin 308 down to engage pin 308 and open the flow path described below.

In some embodiments when lever 331 is moved from the open position to the intermediate position, gas coupling assembly 332 moves down such that gas cylinder head 303 is disposed in receptacle 337, but pin 308 is not engaged. In some embodiments, when lever 331 is moved from the intermediate position to the closed position, gas coupling assembly 332 moves down to sealingly coupled gas cylinder 301 to gas coupling assembly 332 and engage pin 308 and open the flow path described below.

Lever 331 can include a cam system for raising and lowering gas coupling assembly 332. For example, gas coupling assembly 332 can include guides 350 that can be inserted into slots 351 such that lever 331 is coupled to gas coupling assembly 332. In some embodiments, as lever 331 rotates about axis 2, guides 350 move within slots 351 such that gas coupling assembly 332 is raised or lowered. For example, as described above, when lever 331 is moved from the open position to the closed position, gas coupling assembly 332 can move downwards, and when lever 331 is moved from the closed position to the open position, gas coupling 332 can move upwards.

The lever system 330 allows gas coupling assembly to be easily replaceable. For example, to replace gas cylinder 301, a user need only open lever 331, remove gas cylinder 301, insert a new gas cylinder 301 (e.g., by sliding flange 304 into slot 333), and close lever 331. Existing gas cylinders often have threads for screwing them into gas systems. This can be challenging for a lay person. For example, screw connections require relatively precise positioning of the gas cylinder and an amount of rotational force to ensure a tight seal but not too much rotational force that the gas cylinder is overtightened, which also can result in a poor seal. In some embodiments, gas cylinder 301 can be coupled to lever system 330 without any screw mechanisms. In some embodiments, gas cylinder 301 can be installed in any rotational direction without impacting operation of system 100. In some embodiments, system 100 can determine that a new gas cylinder 301 is installed.

As shown in FIGS. 10A and 10B, receptacle 337 can include O-rings 336. In some embodiments, receptacle 337 includes a first O-ring 336 and a second O-ring 336. As shown in FIGS. 10A and 10B, the first and second O-rings 336 can be spaced vertically apart to create a space 338 disposed between the first and second O-rings 336. In some embodiments the two O-rings 336 are integral with each other. In some embodiments, when lever 331 is in the closed position, first and second O-rings 336 are disposed around gas cylinder head 303. In some embodiments, when lever 331 is in the closed position, gas cylinder 301 is fluidly coupled to beverage system 100. For example, when lever 331 is closed, a flow path is formed from an interior of gas cylinder 301 and through gas cylinder outlet 302, space 338, regulator gas inlet 361. In some embodiments, as shown in FIG. 8, gas cylinder 301 can be oriented vertically (i.e., with the gas cylinder head 303 oriented up). In some embodiments, all gas flows out of gas cylinder head 303 horizontally through the flow path described above.

In some embodiments, pin 308 is always engaged when lever 331 is in the closed position. In other words, gas cylinder 301 remains open when lever 331 is in the closed position such that gas cylinder 301 is in fluid communication with regulator 360. In some embodiments, as shown in FIG. 20, gas cylinder 301 can be in fluid communication with one or more carbonators 604. In some embodiments, as shown in FIG. 20, gas cylinder 301 is downstream of water source 702. In some embodiments, gas system 300 can be used to carbonate water. As described in more detail below, system 100 can include various piping systems that allow a user to dispense water having different levels of carbonation.

Gas cylinder 301 can include an identifier tag coupled to an exterior of gas cylinder 301. As described in more detail below related to the electronics system, the identifier tag on gas cylinder 301 allows system 100 to authenticate gas cylinder 301 and track, among other things, the life of the gas cylinder, how long the gas cylinder has been in use, and the estimated remaining life of the gas cylinder. For example, control unit 902 can determine the remaining life of the gas cylinder. In some embodiments, gas cylinder 301's identifier tag is an RFID tag.

In some embodiments, system 100 operates only when gas cylinder 301 is present. For example, in some embodiments, if system 100 determines that gas cylinder 301 is not present, the system will not operate and will not permit water flow through system 100. In some embodiments, system 100 can operate even when gas cylinder 301 is not present or is empty. In some embodiments, system 100 will not display options for carbonated beverages when gas cylinder 301 is not present or is empty.

System 100 can include a filter system (e.g., filter system 400) for filtering water entering system 100. Water can enter system 100 from water system 700. In some embodiments, water system 700 can include various water sources 702, such as household or office water piping. In some embodiments, system 100 is detachably connected to water source 702. In some embodiments, water source 702 is plumbing such that filter system 400 receives water directly from the plumbing system in the building where system 100 is located. In some embodiments, water source 702 is a water reservoir for holding a volume of water, and water is delivered to filter system 400 from the reservoir. In some embodiments the water from the reservoir is boosted into system 100 through a pump. In some embodiments, water from water source 702 is delivered to filter system 400 at a pressure of at least 30 PSI.

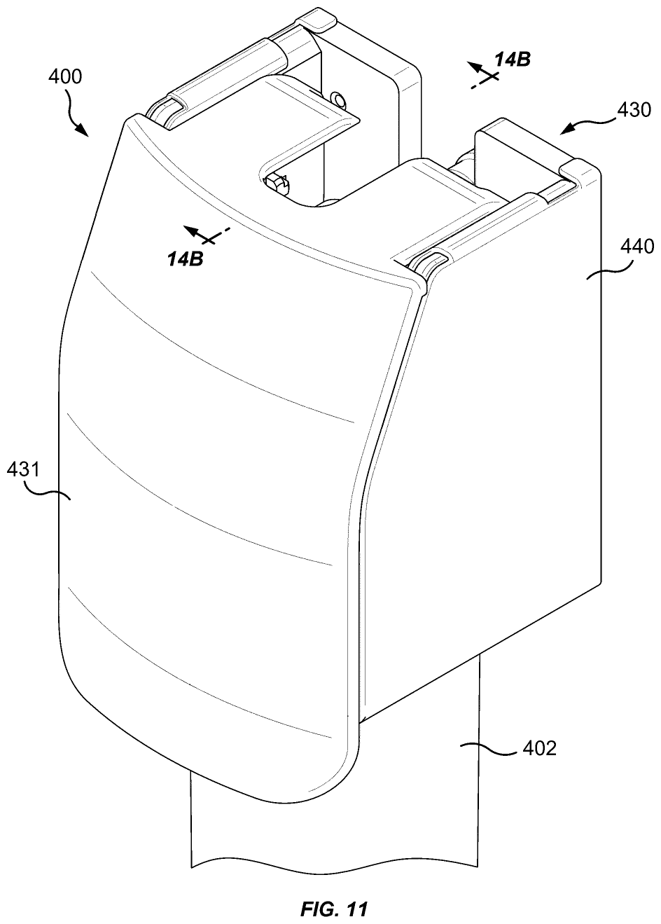

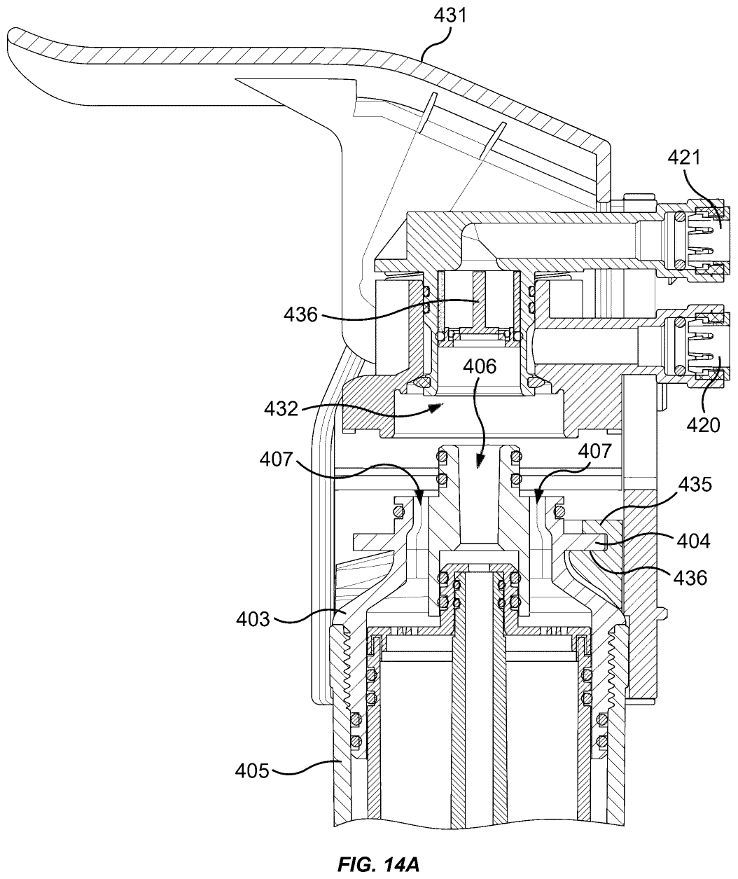

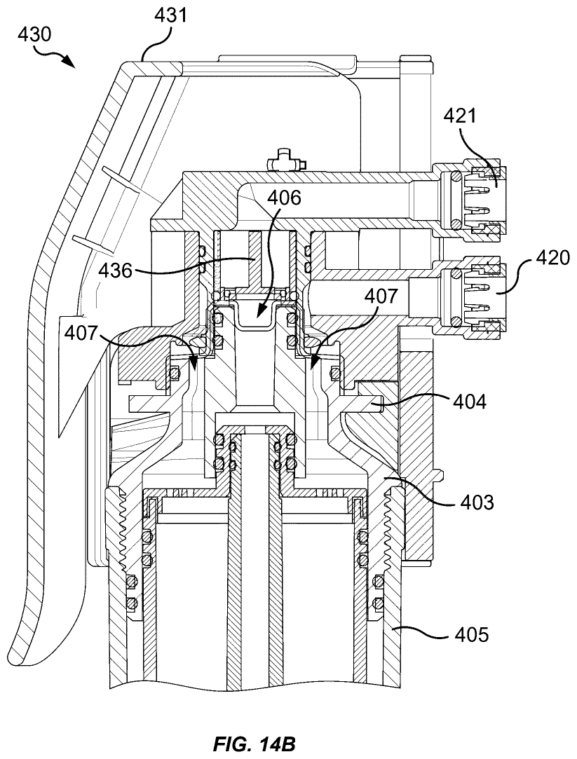

Filter system 400 can include a mounting system for securing filter cartridge 402 to filter system 400. In some embodiments, filter system 400 can include filter cartridge 402, water inlet 420, water outlet 421, and lever system 430. In some embodiments, filter cartridge 402 is replaceable. FIG. 11 illustrates lever system 430 with filter cartridge 402 coupled to lever system 430. In some embodiments, as shown in FIG. 11, lever system 430 can include lever system housing 440 that receives at least a portion of filter cartridge 402. In some embodiments, filter cartridge 402 includes filter head 403 and filter housing 405. Filter head 403 can couple to lever system 430 and an internal volume for housing filter media, for example by flange 404. Various kinds of filter media can be used in filter housing 405. In some embodiments, filter head 403 is removably coupled to filter housing 405. Filter head 403 can include threads that interact with threads of filter housing 405. In some embodiments, filter head 403 can include external threads that interact with internal threads of filter housing 405, as shown in FIGS. 14A and 14B.

Filter cartridge 402 fills with water during use. With typical filters, this means that water can easily spill out of the filter when a used filter is being replaced. In some embodiments, filter head 403 can include one or more valves that opens only when water pressure is applied (i.e., when water is flowing through system 100). In some embodiments, filter head 403 includes two check valves that prevent water from exiting filter system 400 when filter cartridge 402 is removed from lever system 430. This minimizes or eliminates water spillage when filter cartridge 402 is replaced. For example, when lever 431 is opened and water pressure is removed, the valve will close. In other words, the flow path closes so that water in filter cartridge 402 does not spill when filter cartridge 402 is removed.

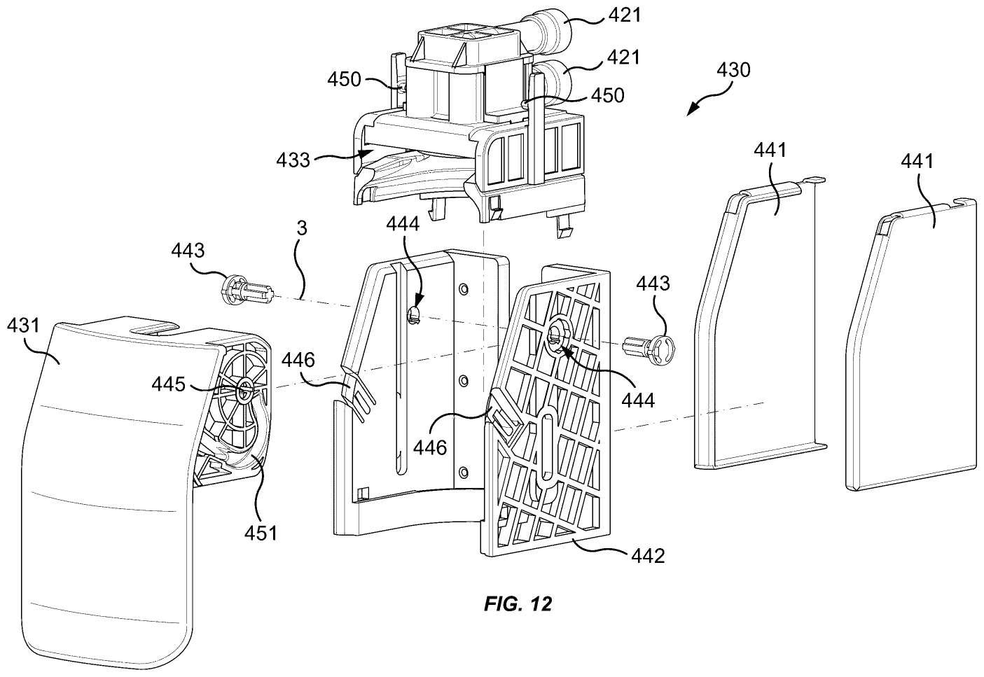

FIG. 12 shows an exploded view of lever system 430. As shown in FIG. 12, lever system 430 can include lever 431, side covers 441, side walls 442, and filter coupling 432. Lever 431 can be rotatably coupled to side walls 442. For example, lever system 430 can include pins 443 that are inserted through holes 444 in side walls 442, as shown in FIG. 12. In some embodiments, opening 445 in a side of lever 431 can receive pin 443 to couple lever 431 to side walls 442. In some embodiments, pin 443 couples to opening 445 by interference fit. In some embodiments, pin 443 includes a head with protrusions around a perimeter of the head, and opening 444 includes recesses around the perimeter of the opening that engage with the protrusions on pin 443. In some embodiments, as lever 431 is rotated, the protrusions engage with the recesses to provide an indication of the position of lever 431. In some embodiments, the indication is an audible indication, a tactile indication, or a combination of both.

Side walls 442 can also include locking tabs 446 that interact with detents on an interior of lever side wall 437. In some embodiments, as lever 431 is moved from the open position to the closed position, detents contact locking tabs 446 such that locking tabs 446 flex outward until detents engage with an opening in locking tabs 446. This holds lever 431 in place, even when the system is operating under pressure. In some embodiments, as lever 431 is moved from the closed position to the open position, detents contact locking tabs 446 such that locking tabs 446 flex outward until detents disengage from locking tabs 446.

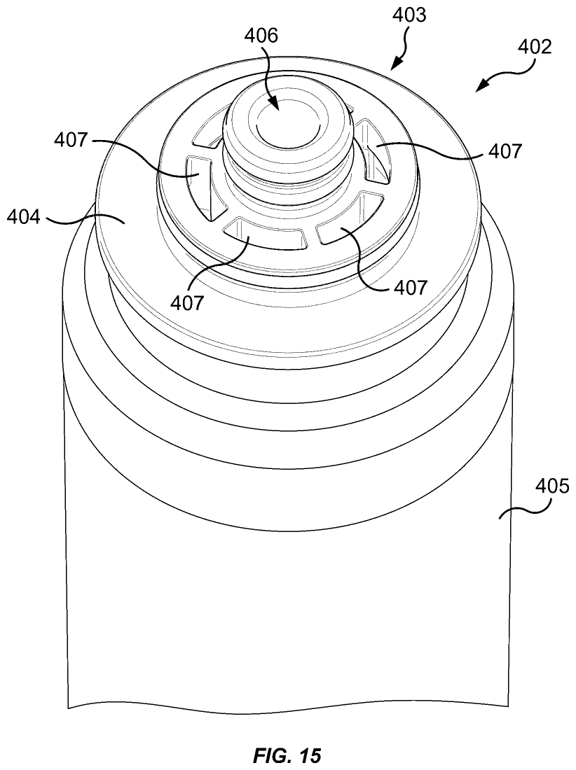

Filter cartridge 402 can include filter water outlet 406 and filter water inlet 407. In some embodiments, filter water outlet 406 is disposed proximate to the center of filter head 403. In some embodiments, filter water inlet 407 includes one or openings. In some embodiments, filter water inlet 407 includes openings disposed concentrically around filter water outlet 406, as shown in FIG. 15.

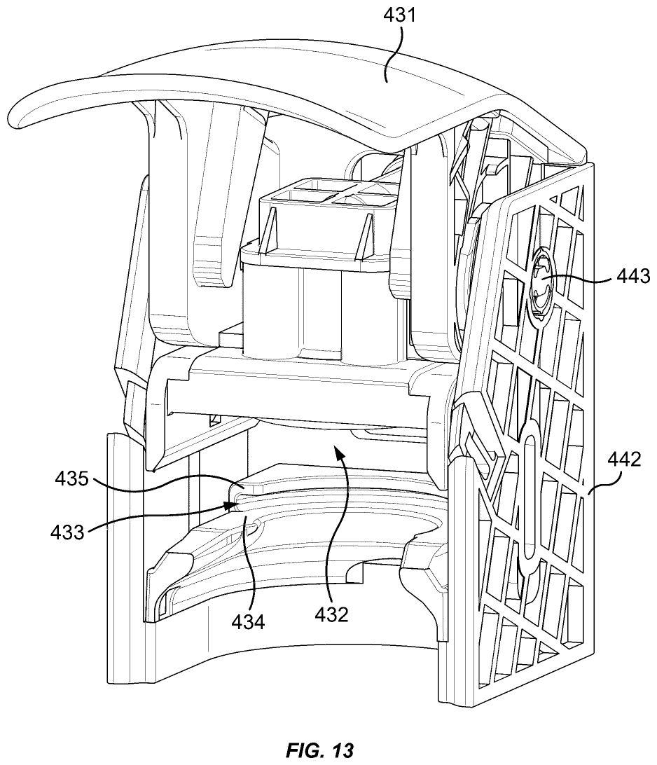

Filter system 400 can include lever system 430 for securing filter cartridge 402 in system 100. Lever system 430 can include lever 431 and filter coupling 432 that creates a seal between filter cartridge 402 and filter water inlet 420 and filter water outlet 421. Filter coupling 432 can include valve 436 that permits flow from water inlet 421 and into filter water outlet 406. In some embodiments, valve 436 is a check valve. Filter coupling 432 can include various components that secure filter cartridge 402 in filter system 400. In some embodiments, filter coupling 432 includes slot 433 defined by lower rim 434 and upper rim 435. In some embodiments, lower rim 434 and upper rim 435 are C-shaped, as shown in FIG. 13. Slot 433 can receive flange 404 of filter cartridge 402. In some embodiments, flange 404 fits tightly into slot 433 to prevent filter cartridge 402 from tilting. Such tilting could break the seal between filter cartridge 402 and filter coupling 432. In some embodiments, slot 433 includes detents in the side of slot 433 that form an interference fit with filter cartridge 402.

FIG. 14A shows a cross-section along line 11-11 with lever system 430 in the open position, and FIG. 14B shows a cross-section along line 11-11 with lever system 430 in the closed position.

Lever system 430 can be configured to raise and lower filter coupling 432 in response to lever 431 moving between an open position (e.g., as shown in FIG. 14A) and a closed position (e.g., as shown in FIGS. 11 and 14B). In some embodiments when lever 431 is moved from the open position to the closed position, filter coupling 432 moves down to couple to filter cartridge 402. As shown in FIG. 14B, when lever 431 is in the closed position, pin filter coupling 432 is moved down to a coupling position. For example, when lever 431 is in the closed position, filter coupling 432 can be coupled to filter head 403. In some embodiments, filter coupling 432 sealingly couples to filter head 403 to form a watertight seal.

In some embodiments, when lever 431 is moved from the closed position to the open position, filter coupling 432 moves up to separate from filter cartridge 402. In some embodiments, when lever 431 is in the closed position, filter cartridge 402 is secured in filter system 400 such that it cannot be removed. In some embodiments, filter cartridge 402 is removable only when lever 431 is in the open position. In some embodiments, lever system 430 includes a cam system for moving filter coupling 432 up and down in response to lever 431 being moved between the open position and the closed position. In some embodiments, lever 431 can include a cam system that moves filter coupling 432 up and down in response to lever 431 being moved between the open position and the closed position.

Lever 431 can include a cam system for raising and lowering filter coupling 432. For example, filter coupling 432 can include guides 450 that can be inserted into slots 451 such that lever 431 is coupled to filter coupling 432. In some embodiments, as lever 431 rotates about axis 3, guides 450 move within slots 451 such that filter coupling 432 is raised or lowered. For example, as described above, when lever 431 is moved from the open position to the closed position, filter coupling 432 can move downwards, and when lever 431 is moved from the closed position to the open position, filter coupling 432 can move upwards.

The lever system 430 allows filter cartridge 402 to be easily replaceable. For example, to replace a filter cartridge, a user need only open lever 431, remove filter cartridge 402, insert a new filter cartridge 402 (e.g., by sliding flange 404 into slot 433), and close lever 431. Existing filters often have threads for screwing filters into water systems. This can be challenging for a lay person. For example, screw connections require relatively precise positioning of the filter and a minimum amount of rotational force to ensure a tight seal not too much rotational force that the filter is overtightened, which also can result in a poor seal. In some embodiments, filter cartridge 402 can be coupled to lever system 430 without any screw mechanisms. In some embodiments, filter cartridge 402 can be installed in any rotational direction without impacting operation of system 100. In some embodiments, system 100 can determine that a new filter cartridge 402 is installed and automatically fill the new filter cartridge 402 with water. This allows system 100 to be immediately ready to dispense a beverage after installing a new filter cartridge 402.

In some embodiments, when lever 431 is in the closed position, the filter media within filter housing 405 is fluidly coupled to beverage system 100. For example, when lever 431 is closed, a flow path is formed from water source 702 to water inlet 420, through filter water outlet 406, filter media disposed within filter housing 405, water filter inlet 407, and water outlet 421. In some embodiments, as shown in FIG. 20, filter cartridge 402 is downstream of water source 702.

Filter cartridge 402 can include an identifier tag coupled to an exterior of filter cartridge 402. As described in more detail below related to the electronics system, the identifier tag on filter cartridge 402 allows system 100 to authenticate filter cartridge 402 and track, among other things, the presence of filter cartridge 402 in system 100, the filter life as established by the filter manufacturer and/or regulatory agencies, how long the filter has been in use, and the estimated remaining life of the filter. For example, control unit 902 can determine the remaining life based on the filter life and the volume of water passed through filter cartridge 402 since it was installed. In some embodiments, electronics system 900 can prompt the user to clean and/or replace filter cartridge 402 based on the amount of time the filter has been in use. In some embodiments, filter cartridge 402's identifier tag is an RFID tag.

In some embodiments, system 100 operates only when filter cartridge 402 is present. For example, in some embodiments, if system 100 determines that a filter cartridge 402 is not present, the system will not operate and will not permit water flow through system 100.

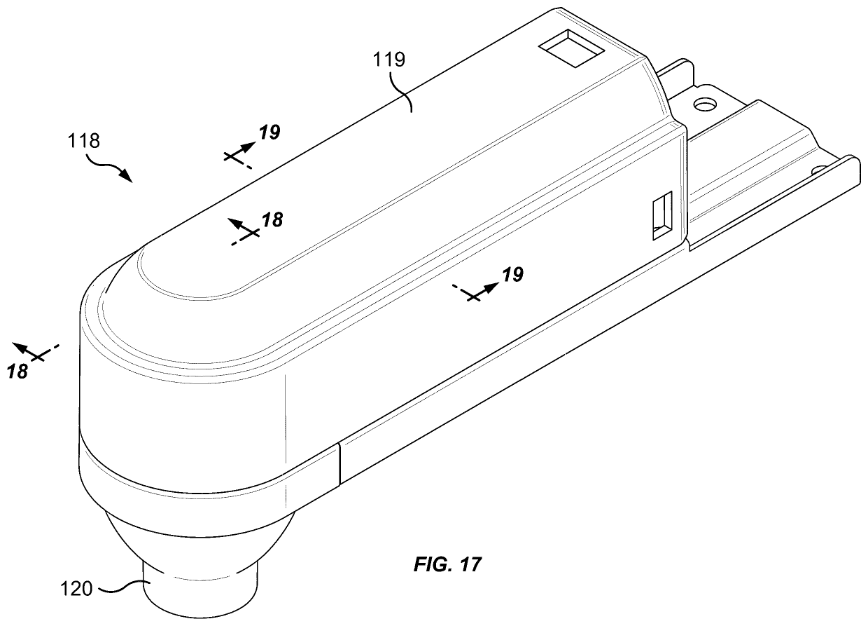

System 100 can include a nozzle (e.g., nozzle 118) for dispensing components of the beverage made by system 100, as illustrated in FIGS. 4 and 17. Nozzle 118 can include nozzle housing 119 and nozzle guard 120. In some embodiments, nozzle guard 120 is removably coupled to nozzle housing 119. In some embodiments, all components of the beverage are dispensed through nozzle 118. In some embodiments, all components are dispensed through separate lines at nozzle 118 and mixed in nozzle 118. For example, in some embodiments, nozzle 118 includes wall 126 that defines a chamber (e.g., chamber 127). In some embodiments, all ingredients and water are dispensed into chamber 127 and are mixed after exiting through nozzle outlet 128.

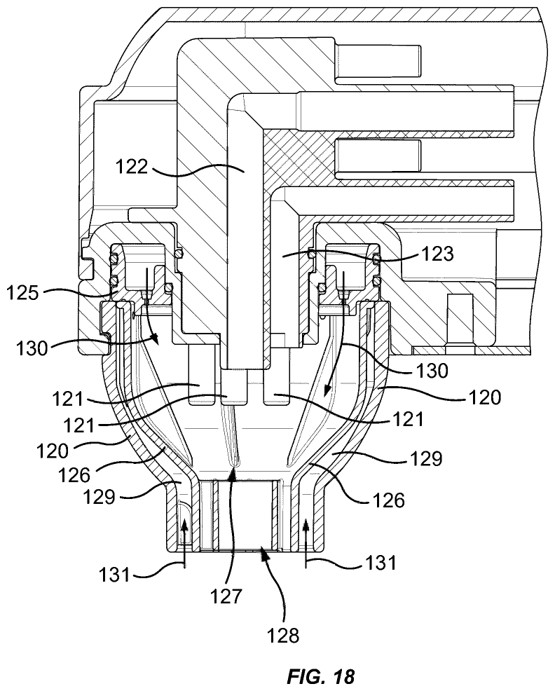

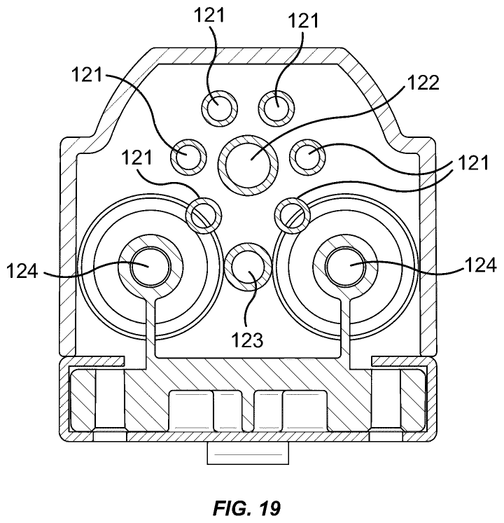

FIG. 18 shows a cross-section of nozzle 118 along line 17A-17A, and FIG. 19 shows a cross-section of nozzle 118 along line 17B-17B. As shown in FIGS. 18 and 19, nozzle 118 can include ingredient outlets 121, hot water outlet 122, steam vent 123, and water lines 124.

In some embodiments, each ingredient cartridge 202 includes a dedicated ingredient outlet 121. For example, as shown in FIG. 4, system 100 can include 6 ingredient cartridges 202 and, as shown in FIG. 19, nozzle 118 can include 6 ingredient outlets corresponding to the 6 ingredient cartridges 202. Accordingly, unlike many existing beverage dispensers, each ingredient added to the beverage will not be in contact with any other ingredients until the ingredients reach nozzle 118. This prevents unintended flavor mixing or cross-over between ingredients.

In some embodiments, nozzle 118 includes hot water outlet 122. In some embodiments, system 100 includes a dedicated hot water line from heating system 800 to hot water outlet 122. For example, in some embodiments, hot water in hot water outlet 122 does not mix with any other component until after flowing through hot water outlet 122.

In some embodiments, nozzle 118 includes steam vent 123 for returning steam generated by the beverage making process back to heating system 800. This improves the efficiency of system 100 by returning heated water back to the heating system every time water stops being dispensed and thus reducing the amount of energy required maintain hot water at the desired temperature. Additionally, this improves the user experience by reducing or eliminating the steam that exits nozzle 118.

In some embodiments, nozzle 118 includes one or more water lines 124. In some embodiments, as illustrated in FIG. 19, nozzle 118 includes two water lines 124. Each water line 124 can dispense sparkling water, still water, or a mixture of both. In some embodiments, one water line 124 dispenses carbonated water and one water line 124 dispenses both carbonated water and still water.

In some embodiments, nozzle 118 includes diffuser 125 for dispensing water from water lines 124. In some embodiments, as shown in FIG. 18, diffuser 125 can be disposed around ingredient outlets 122, hot water outlet 122, and steam vent 123. In some embodiments, diffuser 125 is removably coupled to nozzle 118. Carbonated and/or still water may flow through diffuser 125 as illustrated by arrows 130.

In some embodiments, nozzle 118 includes annular region 129 disposed between wall 126 and nozzle guard 120. Further, wall 126 can include holes proximate to a top of chamber 127 such that air can flow up through annular region 129 (e.g., in the direction shown by arrows 131), through holes proximate to the top of mixing chamber 127, and into chamber 127. This improves the flow of ingredients and water dispensed through nozzle 118. For example, the air flow through annular region 129 and into chamber 127 can make the ingredients and water flow more smoothly through. This improves the flow of ingredients and also improves the user experience by reducing splashing. In some embodiments, all ingredients are mixed after exiting nozzle 118.

Nozzle 118 provides the benefits of many different options for beverages, all mixed at the nozzle itself. For example, as described throughout, system 100 can dispense numerous different ingredients mixed with water having no carbonation or various levels of carbonation. Additionally system 100 can dispense water at various different temperatures. Regardless of the options selected for the beverage, system 100 mixes all components in nozzle 118. This provides a benefit over existing nozzles. For example, unlike nozzle 118, existing multi-ingredient nozzles cannot also dispense hot water. Further, many existing multi-ingredient nozzles cannot mix numerous different ingredients and carbonated or still water at the nozzle itself.

Additionally, unlike many other beverage dispensers, nozzle 118 is not coupled to door 150. For example, many existing systems require that a nozzle and/or nozzle cover be removed before opening a door to access internal components. In some embodiments, door 150 includes a hole through which liquids flow after being dispensed from nozzle 118. In some embodiments, as shown in FIG. 4, when door 150 is opened, nozzle 118 does not move. This makes it easier to access the ingredient cartridges 202, gas cylinder 301, and filter cartridge 402. Additionally, this ensures strong seals are maintained between nozzle 118 and the rest of system 100.

System 100 can include electronics system 900, as described throughout. Electronics system 900 can monitor the status of system 100 and/or consumables (e.g., ingredient cartridges 202, gas cylinder 301, and/or filter cartridge 402). In some embodiments, electronics system 900 monitors the status using camera 904, identifier system 916 and/or sensor system 920. Based on this monitoring of system 100, electronics system 900 can notify the user when consumables are running low or are empty, learn typical use patterns and adapt the system operation based on those learned use patterns. In some embodiments, camera 904 can be used to authenticate a user and/or track consumables.

In some embodiments, electronics system 900 can communicate with a remote user or remote electronic device, for example, through a wireless transceiver. In some embodiments, this communication allows a remote user or remote electronic device to monitor system 100. In some embodiments, electronics system 900 collects data related to the performance and operation of system 100. In some embodiments, the collected data can be used with artificial intelligence and/or machine learning systems to learn trends in machine use, calibrate the system, recommend preventative maintenance, recommend restocking, optimize machine performance, machine operation to improve life of various components of the system, delivery of replacement consumables, etc.

In some embodiments, system 100 is part of a larger automated artificial intelligence-based system. For example, system 100 can be connected to a network of global systems that continuously send/receive data from numerous systems that can include system 100. The data can be used with artificial intelligence and/or machine learning systems to learn trends in machine use, calibrate the system, recommend preventative maintenance, recommend restocking, optimize machine performance. For example, machine performance can be used to track machine performance, predict when certain components are likely to malfunction, and when those components should be replaced. In addition, a machine learning system using a set of functionality data (e.g., temperatures, pressures, flow rates, water quality status, TDS readings, etc.) from one or more systems 100 can optimize the performance of each system based on its effective usage. This can help increase efficiency while reducing energy consumption. This can be beneficial to the end user because, for example, less expensive parts can be preemptively replaced before they fail and potential cause damage to other more expensive components. System 100 can use the artificial intelligence and machine learning to track, among other things, consumption data, user data, and geographic data. This data can in turn be used to predictively and proactively resupply certain flavors or ingredients; suggest others based on consumer preferences; and/or reduce overhead, storage, and maintenance costs by supplying the correct amount of product at the right time, based on consumption data tracked across a network of machines.

In some embodiments, system 100 can be controlled and/or monitored by a remote user or remote device. In some embodiments, based on the monitoring of the system, system 100 can notify the user (e.g., on display 502) that one or more consumables is running low and/or is empty. In some embodiments, the remote computer can automatically fulfill a replacement order for one or more consumables in response to electronics system 900 determining that the one or more consumables is running low and/or is empty. In some embodiments, electronics system 900 can determine, based on data collected from identifier system 916 and/or sensor system 920, that system 100 should be maintained or serviced.

In some embodiments, the artificial intelligence and/or machine learning systems can provide data to a retailer such that the retailer can suggest certain products or flavors based on consumption trends, user preferences, retailer inventory, and/or recommendations from the AI or machine learning system.

In some embodiments, the size of system can be further reduced by use of a remote device that allows for direct end user interaction. For example, the size, associated maintenance costs, energy consumption, and production and sales cost of the system can be further reduced by allowing for end user control via a remote device, thereby eliminating the need for a screen and GUI on the machine itself. Such an embodiment would also allow for more dynamic and specialized user offerings based on data collected and processed by the AI system.

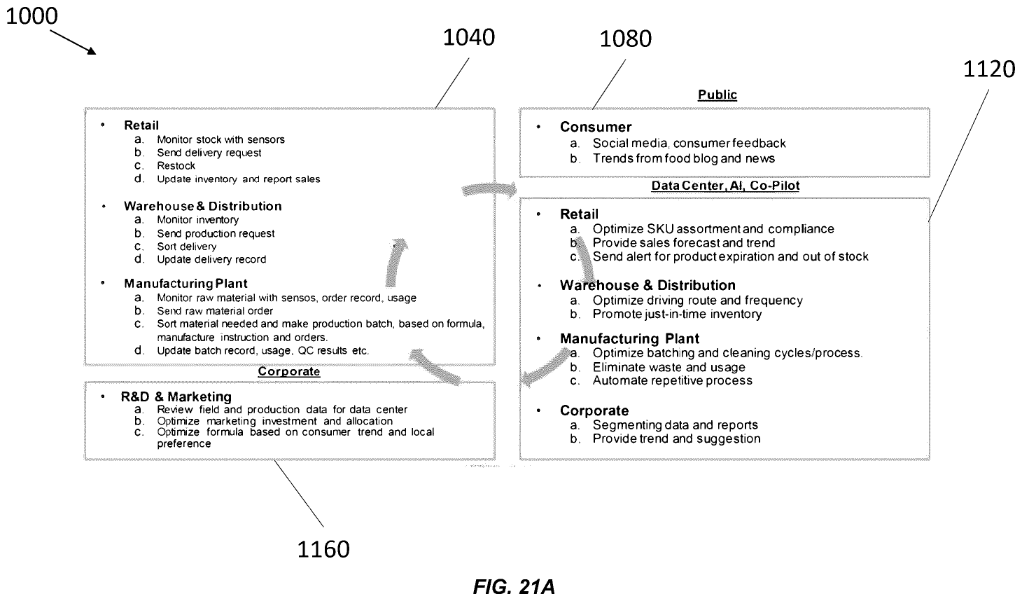

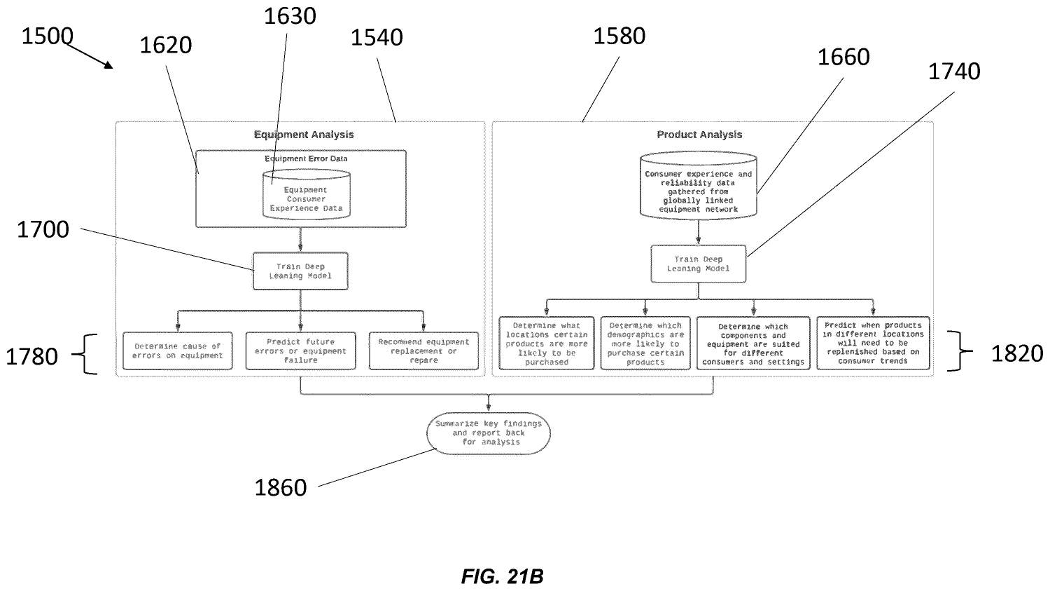

FIG. 21A illustrates a system 1000 for applying machine learning to product maintenance. Any machine learning models or processes mentioned herein can, in some examples, be deep learning models or processes. System 1000 comprises a distribution block 1040 and a reception block 1080. Distribution block 1040 and reception block 1080 each represent multiple possible factors that can be quantified and provided as inputs to Data Center block 1120. Data Center block 1120 represents one or more machine learning models used to identify associations between any inputs, considered individually or in any combination, and any outputs. System 1000 further comprises decision block 1160, which represents decisions regarding product manufacture and distribution that can be made in view of outputs from Data Center block 1120.

Distribution block 1040 comprises sensor data and records relating to sales, logistics, and manufacturing. Distribution block 1040 can comprise, for example, retail data. Retail data can comprise sales volume. For example, retail data can comprise volume of sales to consumers, volume of sales to retailers, or both. In some examples, retail data can be derived from sales records. In further examples, retail data can be derived from sensors within an automated stock monitoring system at a retail location. Retail locations can be, in various examples, a retail store, an automated merchantry system, a controlled access product container, a vending machine, or any other location from which consumers may purchase product. Sensors within the automated stock monitoring system can be, for example, be sensors configured to measure a quantity of product on a shelf or in another storage area. For example, sensors for monitoring a quantity of stock can comprise. When stock falls below a predetermined threshold quantity, an order can be placed automatically or by a human operator for more product to be delivered to the retail location. Upon arrival of the ordered product, the storage space of the retail location can be restocked and inventory and sales records can be updated. In examples wherein the order is placed automatically, the automatic order can also be automatically entered into the sales data. In further examples, the sales data can be updated automatically to reflect changes in stock at the retail location based on the measurements of the quantity of stock by the automated stock monitoring system.

Distribution block 1040 can further comprise warehouse data. Warehouse data can comprise volume of product movement into and out of a warehouse. A warehouse can be, for example, a location where product is stored before distribution to a retail location. In some examples, warehouse data can be derived from shipment and order records. In further examples, warehouse data can be derived from sensors within an automated inventory monitoring system at the warehouse. Similar to the above described automated stock monitoring systems, an automated inventory monitoring system can comprise sensors configured to measure a quantity of inventory of product at the warehouse. Such sensors can comprise, in various examples, weight sensors configured to measure a weight of product stored on a surface or cameras, such as TOF cameras, configured to measure a space occupied by product. Automated inventory monitoring system can further be configured to request production and delivery of product based on inventory data. For example, automated inventory monitoring system can be configured to request production of a product when inventory of the product falls below a predetermined threshold. In further examples, automated inventory monitoring system can be configured to request production of a product at a rate equal to actual or forecasted rates of inventory leaving the warehouse. The rate of inventory leaving the warehouse can be derived from measurements of inventory quantity acquired with the above mentioned sensors of the automated inventory monitoring system. Warehouse data of distribution block 1040 can comprise production requests placed by human operators, production requests placed by automated inventory monitoring systems, or both.

Distribution block 1040 can further comprise manufacturing data. Manufacturing data can comprise raw material quantities, raw material usage rates, and production volume. Manufacturing data can further comprise order volume of raw material. Orders for raw material can be placed, in various examples, by human operators, by automated systems for monitoring raw material quantity or raw material usage, or both. In further examples, manufacturing data can comprise quality control data, such as, for example, a proportion of product found to have defects.

Operations at any of the foregoing sources of information within distribution block 1040, including retail locations, warehouses, and factories or other manufacturing facilities, can be conducted with the assistance of machinery, such as robots or other devices. Such machinery can be automated or human operated. In each location, the machinery can be used to move product, materials, or both. For example, at retail locations, machinery can be used to restock shelves. In further examples, at relocations, machinery can be used to sort products within a storage space. In some examples wherein the machinery comprises an automated robot, the robot can cooperate with the automated stock monitoring system to restock product as orders of new stock arrive at the retail location. Similarly, machinery can be used at a warehouse to sort inventory and otherwise move product about the warehouse. The machinery can be used, for example, to unload newly arrived product from a delivery vehicle, load product onto a delivery vehicle to fulfill orders, or both. Such warehouse machinery can also comprise one or more automated robots. Automated systems can also be used to develop routes for delivery vehicles conveying product to or from the warehouse. Similarly, machinery can be used at a manufacturing facility to transport raw material and product within the facility, unload raw material from a delivery vehicle, load product onto a delivery vehicle, manufacture the product, or any combination of the foregoing.

Any of the above described machinery for use at retail locations, warehouses, or manufacturing facilities can be provided with sensors or any type for monitoring operation of the machinery. For example, the sensors can be configured to take measurements from which product sales, material usage, or both can be derived. The measurements can be comprised by data of distribution block 1040 corresponding to the location of the machinery. Thus, retail data can comprise measurements from sensors of product transportation machinery at retail locations. Warehouse data can similarly comprise measurements from product transportation machinery at warehouses. Manufacturing data can comprise measurements from product or material transportation machinery, measurements from product manufacturing machinery, or both. Additionally or alternatively, the data comprised by distribution block 1040 can comprise logs of operations performed by the machinery, instructions given to the machinery, or both.

Reception block 1080 comprises information gathered related to public opinion regarding the product or products to which distribution block relates or other products in a related category. Reception block 1080 can comprise information acquired by web analytics techniques, such as aggregating discussion of relevant products and concepts from social media, consumer reviews and feedback, blogs, and news. Such aggregated information can be processed to create one or more market insights. The market insights can comprise, for example, whether prevailing attitudes toward a product or product feature are positive or negative, to what degree prevailing attitudes toward a product or product feature are positive or negative, how much certain product types or product features are discussed, what product types or product features are discussed most frequently, or trends concerning any of the foregoing over time.

Data Center block 1120 comprises use of machine learning models to analyze inputs from distribution block 1040 and reception block 1080 and output operational recommendations. All inputs to Data Center block 1120 can be aggregated into a dataset used to train the machine learning models. Data Center block can, in some examples, generate operational recommendations concerning order volume and timing from retail locations to warehouses, from warehouses to manufacturing facilities, and from manufacturing facilities to suppliers of raw materials. In further examples, machine learning model of Data Center block 1120 can be configured to generate operational recommendations concerning what thresholds of stock or inventory at retail locations or warehouses should prompt placement of an order for more product and what the volume of the order should be. Such operational recommendations can be optimized to avoid running out of stock at retail locations or inventory at warehouses. In further examples, such recommendations can be optimized to avoid running out of raw material at a manufacturing plant. Recommendations concerning order placement for product at warehouses and order placement for raw materials and rate of manufacture at manufacturing facilities can be coordinated to minimize a chance of order volume from warehouses exceeding the production capacity of manufacturing facilities. Any such operational recommendations can include prospective changes in order volume according to periodic changes in demand discovered from analysis of information provided to the machine learning models of Data Center block 1120. For example, the machine learning models of Data Center block 1120 may recommend greater order volume, higher stock or inventory thresholds below which orders should be placed, or both, in advance of expected weekly or seasonal increases in demand. In further examples, such operational recommendations can be optimized to reduce a likelihood of product remaining unsold until expiring of raw material remaining unused until expiring by reducing order placement volume or frequency in advance of expected weekly or seasonal decreases in demand. In further examples, relative positivity or negativity of any of a variety of factors, such as, for example, total revenue, total sales, total expenses, wasted product, wasted raw materials, demand exceeding production capacity, defective product occurrence frequency, and running out of stock, inventory, and raw materials, can be weighted and provided to the machine learning models of Data Center block 1120, and the machine learning models can be configured to provide operational recommendations expected to result in maximally positive outcomes. Operational recommendations according to any of the foregoing examples can be provided to human operators or pushed to any automated order placement systems associated with retail locations, warehouses, or manufacturing facilities.

The machine learning models of Data Center block 1120 can also be configured to generate operational recommendations for consideration by business professionals, such as individuals involved in corporate governance. Such operational recommendations can concern, for example, long term forecasts for demand for certain product types, trends in consumer sentiment regarding product types or product features, and recommendations for product development. For example, if the machine learning models of Data Center block 1120 discern from inputs received from reception block 1080 that consumer demand for a product type or product feature not offered by the organization operating the machine learning models, the machine learning models can recommend developing a product of that type or having that feature. Additionally or alternatively, the operational recommendations for consideration by business professionals can comprise recommendations relating to messages to emphasize or avoid in product marketing.

Decision block 1160 comprises consideration of the operational recommendations output by the machine learning models of Data Center block by any human recipients of the operational recommendations. The human recipients comprise, in various examples, engineers, research and development teams, marketing professionals, business professionals, factory operators, vehicle operators, or any other recipients appropriate for the subject matter of the recommendations given. At decision block 1160, the human recipients determine which operational recommendations from the machine learning models of Data Center block to implement and to what extent those recommendations will be implemented. For example, certain product development recommendations may be implemented, whereby new products may be developed and then produced at manufacturing facilities, while other product development recommendations may be ignored or deferred. Similarly, logistics related operational recommendations may be implemented throughout the various elements of decision block 104, such as by altering order volumes, order frequencies, delivery routes, workflows in manufacturing facilities, and traffic patterns within storage areas of retail locations, warehouses, and manufacturing facilities. In further examples, certain marketing recommendations may be implemented, such as by adjusting marketing investment across various media, various locations, or both. In still further examples, marketing recommendations can be implemented by developing new marketing campaigns, retiring certain existing marketing campaigns, or both.

FIG. 21B illustrates an analytic structure 1500. In some examples, analytic structure 1500 can be a process within Data Center block 1120 of the above described system 1000. In further examples, analytic structure 1500 can be implemented independently from the above described system 1000.

Analytic structure 1500 can comprise equipment analysis 1540 and product analysis 1580. Equipment analysis 1540 can be implemented with workflow 2000 and system 3000 described below to analyze a type of equipment, such as machine 3400, also described below. Equipment analysis 1540 begins from receiving input data 1620. Consumer experience data 1630 can comprise any data relating to usage by consumers of the type equipment being analyzed. Consumer experience data 1630 can comprise, for example, consumer sentiment and feedback acquired in reception block 1080, survey data, data related to measurements of how consumers interact with machines, or any combination of the foregoing.

Equipment analysis 1540 comprises a training step 1700 wherein input data 1620 of equipment analysis 1540 is used to train a machine learning model, which can, in some examples, be a deep learning model. The machine learning model is trained to produce outputs 1780 from input data 1620. Outputs 1780 of equipment analysis 1540 can comprise or be comprised by the operational recommendations described above with regard to Data Center block 1120 of system 1000. Outputs 1780 of equipment analysis 1540 can comprise, for example, identified causes of failures of the type of equipment being analyzed, predictions of future error and failure patterns for the type of equipment being analyzed, recommended maintenance, such as replacement or repair, of existing instances of the type of equipment being analyzed, or any combination of the foregoing.

Product analysis 1580 comprises using product data 1660 to train a machine learning model in a training step 1740 of product analysis 1580. The machine learning model can be, in some examples, a deep learning model. Product data 1660 can comprise sales data of a product, usage data of equipment consumers may use to purchase the product, consumer sentiment and feedback acquired in reception block 1080, survey data, and reliability data of equipment consumers may use to purchase the product.

In training step 1740 of product analysis 1580, the machine learning model is trained to produce outputs 1820 from product data 1660. Outputs 1820 of product analysis 1580 can comprise or be comprised by the operational recommendations described above with regard to Data Center block 1120 of system 1000. Outputs 1820 of product analysis 1580 can comprise, for example, predictions of locations where certain products are likely to be purchased, identifications of demographics associated with groups of consumers that purchase certain products, predictions which types of equipment are suitable for which consumers and settings, predictions of which locations are likely to run out of stock and require restocking, or any combination of the foregoing.

Analytic structure 1500 terminates at report step 1860. At report step 1860, all or some portion of outputs 1780, 1820 of equipment analysis 1540 and product analysis 1580 can be reported to decision makers. Decision makers for this purpose can, in some examples, be any of the human recipients described above with regard to decision block 1160 of system 1000. Report step 1860 can include identification of key findings within outputs 1780, 1820 or otherwise summarizing or abbreviating outputs 1780, 1820 before reporting outputs 1780, 1820 to the decision makers.

Workflow 2000 further comprises a loading step 2080. Loading step 2080 comprises loading system 3000 with the feedback expected from the machine in response to the user inputs provided in setup step 2040. Loading step 2080 can further comprise loading system 3000 with any instructions that remain to be provided after setup step 2040. Loading step 2080 can comprise, for example, loading system 3000 with instructions concerning what actions to take when the machine deviates from the expected feedback. For example, loading step 2080 can comprise loading system 3000 with instructions to record a deviation from the expected feedback along with data relating to the circumstances of the deviation. Loading step 2080 can further comprise instructions concerning which kinds of deviations to record.

Workflow 2000 further comprises an attempt step 2120. Attempt step 2120 can follow setup step 2040 and loading step 2080. Attempt step 2120 comprises the system attempting a next action within the user inputs provided in setup step 2040. If attempt step 2120 is the first attempt step 2120 performed within an instance of workflow 2000, attempt step 2120 can comprise attempting a first one of the user inputs provided in setup step 2040. Attempt step 2120 can be, for example, any of the actions performable by system 3000 discussed below. Thus, examples of actions performable in attempt step 2120 include touching a touch screen on an interface, pressing a button on an interface, submitting payment, opening a door, and any combination or sequence of the foregoing. In further examples, attempt step 2120 can be system 3000 simulating a user input to interface 3010 of the machine.

In some embodiments, system 100 can operate in various modes, for example an end-user mode, a replacement mode, a service mode, and an engineering mode.

In some embodiments, in the end-user mode electronics system 900 can display on display 502 an end-user interface. In the end-user interface, the user can interact with display 502 to prepare a beverage. In the end-user interface, the user may select various beverage options. In some embodiments, the options include ingredients, strength of carbonation, strength of flavor, temperature, volume of beverage, or combinations thereof. In some embodiments, the end-user mode can include various classifications of end users. Each classification of end user can have different menu options, different pricing plans, and/or varying quantities of consumables that can be served over a predetermined period of time. For example, a first end user classification can provide access to a subset of the available ingredients in ingredient cartridges 202 while a second end user classification can provide access to all available ingredients in ingredient cartridges 202.

In some embodiments, in the replacement mode electronics system 900 prompts a user on display 502 to replace one or more of the consumables (e.g., ingredient cartridges 202, gas cylinder 301, and/or filter cartridge 402). In some embodiments, in the replacement mode, display 502 displays an authentication field (e.g., a PIN field and/or password field) prompting the user to authenticate by entering a PIN and/or a password. Upon successful authentication, electronics system 900 can unlock lock 906, which can allow the user to open door 150. Once door 150 is open, display 502 can display instructions for replacing one or more consumables. In some embodiments, once door 150 is open, the user can install new consumables as described below related to the methods of installing an ingredient cartridge 202, gas cylinder 301, and/or filter cartridge 402. In some embodiments, in the replacement mode, electronics system 900 can provide an indication (e.g., with indicator lights 910 or on display 502) that the new consumable has been successfully installed. In some embodiments, after successful installation, electronics system 900 can prompt the user to close the door. In some embodiments, electronics system 900 automatically locks lock 906 when door 150 is closed (e.g., by latch 154).

In some embodiments, in the service mode electronics system 900 prompts a user on display 502 that system 100 needs to be serviced. In some embodiments, system 100 cannot dispense a beverage when system 100 is in the service mode. In some embodiments, in the service mode, display 502 displays an authentication field (e.g., a PIN field and/or password field) prompting the user to authenticate by entering a PIN and/or a password. In some embodiments, the authentication is different than the authentication for the replacement mode. Upon successful authentication, electronics system 900 can unlock lock 906, which can allow the user to open door 150. Once door 150 is open, display 502 can display instructions for servicing. In some embodiments, in the service mode, electronics system 900 can provide an indication (e.g., with indicator lights 910 or on display 502) that the service is complete and/or successful. In some embodiments, after service, electronics system 900 can prompt the user to close the door. In some embodiments, electronics system 900 automatically locks lock 906 when door 150 is closed (e.g., by latch 154).

In some embodiments, in the engineering mode electronics system 900 can test various components of system 100, calibrate system 100, and receive communication from a remote user and/or remote computer. In some embodiments, in engineering mode, a remote user and/or remote computer can remotely control operation of system 100. In some embodiments, system 100 can be in engineering mode at the same time as the end-user mode, the replacement mode, or the service mode.

As shown in FIG. 20, inlet water can flow from water source 702 through water line 12 to filter cartridge 402. In some embodiments, the inlet water is water from water source 702 as described above related to filter system 400. Inlet water can be filtered by filter cartridge 402, and filtered water can exit filter 402 through filtered water line 14. As shown in FIG. 20, filtered water line 14 can split and deliver water to, for example, chiller bucket 602, nozzle 118, hot water tank 802. Chilled water from chiller bucket 602 can exit through chilled water line 22. In some embodiments, the chilled water has a temperatures from about 0° C. to about 10° C., from about 2° C. to about 8° C., from about 5° C. to about 7° C., or within a range having any two of these values as endpoints. In some embodiments, as shown in FIG. 20, chilled water line 22 can split into chilled water line 22 and mixed water line 24. Chilled water line 22 can be provided directly to nozzle 118 for making a still beverage, or it can be mixed with a carbonated water line at different ratios to produce a carbonated beverage with different levels of carbonation.

Mixed water line 24 can mix with filtered water line 14 at different ratios to produce still water having different temperatures. For example, mixed water line 24 can include a mixture of chilled water and filtered water at ambient temperature in a ratio of from about 30:70 to about 70:30 (e.g., from about 40:60 to about 60:40, or about 50:50). In some embodiments, the chilled water and filtered water at ambient temperature are mixed in a ratio of 50:50. In some embodiments, the still water used for making beverages can be at a temperature from about 10° C. to about 35° C., from about 15° C. to about 30° C., from about 20° C. to about 25° C., or within a range having any two of these values as endpoints. After mixing, the water can be provided directly to nozzle 118 for making a still beverage, or it can be further mixed with a carbonated water line at different ratios to produce a carbonated beverage with different levels of carbonation and different temperatures.

As shown in FIG. 20, gas cylinder 301 can provide gas (e.g., carbon dioxide) to the system through gas line 10. Gas line 10 can provide gas to carbonators 604 in chiller bucket 602. In some embodiments, carbonators 604 mix the gas from gas line 10 with water in the chiller bucket to generate carbonated water. The carbonated water can flow through carbonated water line 20. Carbonated water line 20 can split into 2 or more lines. In some embodiments, carbonated water line 20 splits into two lines and a first line provides carbonated water to nozzle 118 and a second line mixes the carbonated water with one or more of the chilled still water in chilled water line 22, the mixed still water line in mixed still water line 24, or still water in filtered water line 14. In some embodiments, the first line provides carbonated water to the nozzle having a carbon dioxide concentration of from about 2.9% to about 3.3% (e.g., from about 3.1% to about 3.2%, or about 3.1%) (v/v). In some embodiments, the carbonated water mixes with the chilled still water at a ratio sufficient to achieve a carbon dioxide concentration from about 2.1% to about 2.5% (e.g., from about 2.2% to about 2.4%, or about 2.3%) (v/v). In some embodiments, the carbonated water mixes with the chilled still water at a ratio sufficient to achieve a carbon dioxide concentration from about 1.6% to about 2.0% (e.g., from about 1.7% to about 1.9%, or about 1.8%) (v/v).

As shown in FIG. 20, hot water tank 802 receives filtered water from filtered water line 14 and provide the heated water to nozzle 118 through heated water line 16 for making a beverage. In some embodiments, the heated water is provided at less than 100° C. In some embodiments, the heated water is provided at a temperature from about 65° C. to about 95° C., from about 75° C. to about 85° C., or within a range having any two of these values as endpoints. Nozzle 118 can return steam to hot water tank 802, as described above related to heating nozzle 118, through steam line 18.

As shown in FIG. 20 ingredient lines 26 can transfer ingredients from ingredient cartridges 202 to nozzle 118. In some embodiments, ingredient lines 26 include hoses 240, shown in FIGS. 5, 7A, 7B. In some embodiments, each ingredient cartridge 202 includes a dedicated ingredient line 26, as shown in FIG. 20. In some embodiments, each ingredient line 26 includes pump 270 for pumping ingredients from ingredient cartridges 202 to nozzle 118.

As shown in FIG. 20, ingredients and water at various temperatures and at various carbonation levels can all be delivered to nozzle 118. In some embodiments, as discussed above, all components can be mixed just after being dispensed from nozzle 118 (e.g., at mixing line 28).

As shown in FIG. 20, filtered water line 14 can include delivery pump 170 that pumps filtered water in filtered water line 14 to one or more components, such as chiller bucket 602 and/or nozzle 118.

System 100 may include a sensor system 920 that includes various sensors for monitoring the status of system 100 and various components of the system. In some embodiments, sensor system 920 can communicate with other components of system 100.

In some embodiments, sensor system 920 includes one or more temperature sensors. In some embodiments, sensor system 920 includes a first temperature sensor 922 that detects the temperature of inlet water (i.e., water flowing from water system 700 into system 100). In some embodiments, sensor system 920 includes a second temperature sensor 922 that detects the temperature of liquid dispensed from system 100 (e.g., liquid exiting system 100 through nozzle 118). In some embodiments, control unit 902 activates heating system 800 in response to one or more of the temperatures sensors 922 detecting that water flowing through the system is at or below a predetermined temperature. For example, in some embodiments, control unit 902 activates heating system 800 in response to temperature sensor 922 detecting that the temperature of the water is less than or equal to 85° C. (e.g., less than or equal to 90° C. or less than or equal to 95° C.).

In some embodiments, sensor system 920 includes one or more sensors for monitoring total dissolved solids (“TDS”). In some embodiments, sensor system 920 includes TDS sensor 932 upstream of filter system 400 for detecting total dissolved solids in the water entering filter system 400. In some embodiments, sensor system 920 includes TDS sensor 934 downstream of filter system 400 for detecting total dissolved solids in the water after filtration. In some embodiments, sensor system 920 includes a TDS sensor 932 upstream of filter system 400 and a TDS sensor 934 downstream of filter system 400. The detected TDS levels may be used to determine the status of filter cartridge 402. For example, the difference between the TDS detected upstream of the filter and TDS detected downstream of the filter is too small, control unit 902 may provide an indication to the user that the filter is at end of life or that the filter is clogged.

In some embodiments, sensor system 920 includes one or more pressure sensors. The pressure sensors may be used for monitoring, for example, water pressure and carbon dioxide pressure. In some embodiments, sensor system 920 includes water pressure sensor 926 for detecting water pressure. In some embodiments, water pressure sensor 926 may detect pressure of inlet water. In some embodiments, sensor system 920 includes gas pressure sensor 928 for measuring pressure of gas from gas cylinder 301. In some embodiments, the pressure measured by gas pressure sensor 928 can be used to determine the remaining life of gas cylinder 301. For example, in some embodiments, control unit 902 may use the pressure measured by gas pressure sensor 928 to calculate a remaining life of gas cylinder 301. In some embodiments, control unit 902 may provide, based on the pressure measured by gas pressure sensor 928, an indication to the user that the gas level in gas cylinder 301 is low. In some embodiments, when the pressure measured by gas pressure sensor 928 is less than or equal to 150 PSI, control unit 902 may provide an indication to the user that the gas level in gas cylinder 301 is low. In some embodiments, when the pressure measured by gas pressure sensor 928 is less than or equal to 100 PSI, control unit 902 may provide an indication to the user that gas cylinder 301 is empty.

In some embodiments, chiller bucket 602 includes a level sensor for detecting the level of water in chiller bucket 602. In some embodiments, the level sensor includes a float continuous level sensor and/or a conductivity probe. In some embodiments, the level sensor sends a signal when it detects that the level of water in chiller bucket 602 is below a predetermined level. In some embodiments, control unit 902 is configured to communicate with water system 700 to add more water to chiller bucket 602 in response to the level sensor indicating that the level of water in chiller bucket 602 is below a predetermined level. In some embodiments, level sensor sends a signal when it detects that the level of water in chiller bucket 602 is above a predetermined level. In some embodiments, control unit 902 is configured to provide an indication to the user (e.g., on display 502) that the water level in the chiller bucket 602 is too high. In some embodiments, the indication is an alert to open drain 606 of chiller bucket 602. In some embodiments, control unit 902 is configured to communicate with drain 606 to automatically open drain 606 in response to the level sensor detecting that the level of water in chiller bucket 602 is above a predetermined level.

In some embodiments, system 100 includes drip tray 160 that is removably coupled to system 100. In some embodiments, sensor system 920 includes a drip tray presence sensor configured to detect whether drip tray 160 is coupled to system 100. In some embodiments, control unit 902 is configured to provide an indication to the user (e.g., on display 502) in response to drip tray presence sensor detecting that drip tray 160 is not coupled to system 100. In some embodiments, system 100 will not operate when drip tray 160 is not detected. In some embodiments, sensor system 920 includes a drip tray level sensor configured to detect the level of liquid in drip tray 160. In some embodiments, drip tray level sensor is configured to send a signal when the level of liquid in drip tray 160 reaches a predetermined level. In some embodiments, control system 920 is configured to provide an indication to the user (e.g., on display 502) in response to drip tray level sensor detecting that the level of liquid in drip tray 160 has reached a predetermined level. In some embodiments, system 100 will not operate when drip tray level sensor detects that the level of liquid in drip tray 160 has reached a predetermined level.

In some embodiments, sensor system 920 includes a user proximity sensor configured to detect when a user is within a predetermined distance of system 100. In some embodiments, control unit 902 is configured to turn off system 100 when a user is not detected within a predetermined distance of system 100. For example, control unit 902 can be configured to turn off system 100 when a user has not been detected within a predetermined distance for a predetermined time. In some embodiments, control unit 902 is configured to turn on system 100 when a user is detected within a predetermined distance. In some embodiments, the predetermined distance is 2 or more feet (e.g., 3 or more feet, 5 or more feet, or 10 or more feet). In some embodiments, the predetermined time is 1 or more minutes (e.g., 2 or more minutes, 5 or more minutes, or 10 or more minutes).

In some embodiments, sensor system 920 includes one or more NTC thermistors for monitoring various components of the refrigeration and carbonation system 600. In some embodiments, sensor system 920 includes three NTC thermistors, for example, a first NTC thermistor for determining the status of the compressor, a second NTC thermistor for measuring the temperature of the chilled water, and third NTC thermistor for determining the speed of an agitator.

In some embodiments, sensor system 920 includes one or more NTC thermistors for monitoring various components of the heating system 800. In some embodiments, sensor system 920 includes a thermistor for measuring the temperature of water inside of a hot tank of heating system 800. In some embodiments, sensor system 920 includes a thermistor on/off sensor for automatically turning the heater on or off based on the temperature of water in the hot tank. In some embodiments, system 100 cycles the heating element by the tank temperature target.

In some embodiments, sensor system 920 includes a door sensor for determining whether door 150 is opened or closed. In some embodiments, system 100 cannot dispense a beverage unless the door sensor determines that door 150 is closed. In some embodiments, control unit 902 will prevent system 100 from dispensing a beverage when the door sensor determines that door 150 is opened.

In some embodiments, sensor system 920 includes ingredient level sensors for determining the level of ingredients in ingredient cartridges 202. In some embodiments, sensor system 920 includes one ingredient level sensor for each ingredient cartridge 202. In some embodiments, system 100 is configured to provide an indication to the user based on the ingredient level as determined by the ingredient level sensor(s). For example, in some embodiments, system 100 provides an indication that an ingredient cartridge 202 is low in response to the ingredient level sensor determining that the ingredient level is below a first predetermined level. In some embodiments, system 100 provides an indication that an ingredient cartridge 202 is empty in response to the ingredient level sensor determining that the ingredient level is below a second predetermined level that is lower than the first predetermined level.

In some embodiments, sensor system 920 includes a vessel pressure sensor for determining whether a vessel (e.g., a beverage container) is within a dispensing area. The dispensing area, can be below nozzle 18. In some embodiments, system 100 cannot dispense a beverage unless the vessel pressure sensor determines that a vessel is within a dispensing area. In some embodiments, control unit 902 will prevent system 100 from dispensing a beverage when the vessel pressure sensor determines that a vessel is not within a dispensing area. In some embodiments, a QR code reader can be used to detect the presence of a vessel. In some embodiments, a camera can detect the presence of a vessel. In some embodiments, sensor system 920 includes a sensor that can detect a height of a vessel, and the control unit can be configured to fill determine a fill height based on the height of the vessel.

In some embodiments, sensor system 920 includes a gas mass sensor configured to determine the mass of gas within gas cylinder 301. In some embodiments, the remaining life of gas cylinder 301 can be determined based on the mass of gas as detected by the gas mass sensor.

In some embodiments, system 100 includes an identifier system 916 for reading identifier tags on, for example, ingredient cartridge 202, gas cylinder 301, or filter cartridge 402. As described above related to ingredient cartridge 202, gas cylinder 301, or filter cartridge 402, the identifier system can allow system 100 to track various aspects of the consumable devices.

In some embodiments, sensor system 920 includes a QR code reader, a barcode reader, a Near Field Communication (“NFC”) reader, Narrow Band Internet of Things (“NB-IoT”) reader, a Bluetooth Low Energy (“BLE”) reader.

In some embodiments the sensor system 920 includes one or more asset tracking sensors, such as QR code readers, RFID tags, barcode readers, NFC, NB-IoT, and/or GPS. These sensors can be used for various purposes, such as: product, component, or user authentication; to ensure that no counterfeit, defective, out of date, expired, unauthorized, components or flavor concentrates are used; tracking consumption and user preferences associated with a particular machine; user identification and tracking; and/or payment. These systems can be used, for example, to determine whether a compatible ingredient cartridge 202 is being used with system 100 or to communicate with a mobile phone or an authentication device of the end user's (e.g., a mobile phone app or an identification badge). Additionally, these systems can be used to ensure only authorized users are allowed access to other user modes (e.g., replacement mode, service mode, or engineering mode). For example, one or more of the foregoing can be used to ensure that: (1) only compatible flavor cartridges are used; (2) only a user with the correct ID badge is allowed to replace cartridges or perform maintenance; or (3) only users with an employee ID badge are served.

In some embodiments, sensor system 920 includes a QR code reader that can read a QR code on a vessel. This allows for a user to refill a reusable vessel. In some embodiments, system 100 can authenticate the user based on the QR code on the vessel.

In some embodiments, sensor system 920 includes a leak detection sensor for detecting leaks inside of system 100. In some embodiments, the system 100 can automatically shut off if the leak sensor detects a leak inside of system 100. In some embodiments, the system 100 can provide a notification to the user that a leak is detected in response to the leak sensor detecting a leak inside of system 100.

In some embodiments, system 100 includes one or more flow meters for determining the flow rate of various fluid streams within system 100. The flow meters can provide information about the status of various components of system 100. For example, if the flow rate is too low, that can indicate the filter is clogged and needs to be replaced and/or cleaned. In some embodiments, electronics system 900 can prompt the user to clean and/or replace filter cartridge 402 based on the flow rate as determined by the one or more flow meters.

In some embodiments, system 100 includes a GPS for determining the geoposition of system 100.

In some embodiments, sensor system 920 includes one or more current detection sensors for detecting current through various components of the system. In some embodiments, system 100 can determine the estimated life span of various components based on the current detection sensors detection. In some embodiments, current readings from current detection sensors outside of a predetermined range an can be used, among other things, be used to detect or predict potential issues with various components, determine whether various components are functioning, and to optimize energy consumption. Further, the current reading from current detection sensors can determine power consumption of components (e.g., refrigeration compressor). This can be used to detect faulty or worn out components. For example, more current increases may be indicative of a faulty or worn out motor or pump.

In some embodiments, system 100 may include indicator system 908 for providing an indication of the status of one or more of the consumables. In some embodiments, the indicator system 908 can provide notifications to the user. In some embodiments, the notifications are audible (e.g., through audio unit 914) or visual (e.g., through display 502 or through one or more indicator lights 910.

In some embodiments, indicator system 908 can provide text notifications on display 502. In some embodiments, indicator system 908 can provide visual notifications with indicator lights 910. In some embodiments, each indicator light 910 is an LED light. In some embodiments, indicator light 910 may change colors based on the current status of various components of dispensing system 100. In some embodiments, system 100 includes one indicator light 910 for each consumable cartridge.

For example, as shown in FIG. 4, in some embodiments, system 100 includes indicator lights 910a to 910/corresponding to ingredient cartridge slots 102a to 102f; indicator light 910g corresponding to gas cylinder slot 104; and indicator light 910h corresponding to filter cartridge slot 106. In some embodiments, each indicator light may illuminate a certain color depending on the status of the respective consumable cartridge. For example, indicator lights 910a-h may illuminate white when their respective slots have received a consumable cartridge and the consumable cartridge is operating normally. In some embodiments, indicator lights 910a-h may illuminate red when the slots have received a consumable cartridge and the consumable cartridge is empty. In some embodiments, indicator lights 910a-h may illuminate blue when the slots do not have a consumable cartridge coupled to the slot. In some embodiments, indicator lights 910 may flash to indicate an error or warning related to a consumable coupled to the slot.

In some embodiments, indicator lights 910 may illuminate in response to a signal from one or more sensors from sensor system 920. For example, indicator lights 910 can change colors as described above in response to sensor system 920 detecting that a consumable is low, empty, or not present.

System 100 may include refrigeration and carbonation system 600 for chilling water before dispensing. In some embodiments, refrigeration and carbonation system 600 includes chiller bucket 602 for storing chilled water. In some embodiments, chiller bucket 602 is configured to maintain the temperature of the chilled water from greater than 0° C. to less than 10° C. (e.g., from about 1° C. to about 8° C.).

Chiller bucket 602 can include one or more carbonators 604 for mixing chilled water with carbon dioxide from gas system 300. In some embodiments, chiller bucket includes two carbonators 604 in parallel, as shown in FIG. 20. In some embodiments, chiller bucket 602 includes an internal chilling coil. In some embodiments, chiller bucket 602 has a capacity of from about 2 L to about 10 L, from about 3 L to about 9 L, from about 4 L to about 8 L, from about 5 L to about 7.7 L, from about 6 L to about 7 L, or within a range having any two of these values as endpoints. In some embodiments, chiller bucket 602 has a capacity of from about 7 L to about 8 L. In some embodiments, chiller bucket 602 has a capacity of about 7.7 L. In some embodiments, chiller bucket 602 includes drain 606, as illustrated in FIG. 20. In some embodiments, refrigeration and carbonation system 600 includes the refrigeration system shown, for example, in U.S. Patent Pubs. 2021/0380390, 2020/0361758, each of which is incorporated herein by reference.

System 100 may include heating system 800 for heating liquids to a desired temperature. For example, heating system 800 can be used to heat water that is flowing to nozzle 118. In some embodiments, heating system 800 can be used to heat water to a temperature from about 85° C. to about 95° C.

In some embodiments, heating system 800 may include a hot water tank (e.g., tank 802). In some embodiments, tank 802 has a capacity from about 0.5 L to about 2 L, from about 0.75 L to about 1.5 L, from about 1 L to about 1.25 L, or within a range having any two of these values as endpoints. In some embodiments, tank 802 has a capacity of about 1 L. In some embodiments, tank 802 is a passive hot water tank. Tank 802 may be divided into two portions, for example, a main heating chamber and an upper steam chamber. In some embodiments, the main heating chamber includes a heating element protected by a stainless-steel shirt. In some embodiments, the upper steam chamber includes a steam venting pipe reaching the back of the nozzle. In some embodiments, heating system dispenses hot water against gravity. This allows any water remaining in the pipe when dispensing to return back into the hot water tank rather than remaining inside the dispensing pipe and cooling down. In some embodiments, heating system 800 includes the heating system shown, for example, in FIGS. 2A, 2B, 2G, 6A, 11A, and 11E of U.S. Patent Pub. 2020/0361758, which is incorporated herein by reference.

System 100 may include a ventilation system to remove heat from system 100. In some embodiments, system 100 can include a fan that blows air out of system 100, for example through vent holes 113 in one or more side walls 112. In some embodiments, the ventilation system includes the ventilation system shown, for example, in U.S. Patent Pubs. 2021/0380390, 2020/0361758, each of which is incorporated herein by reference.

A user may interact with the system 100 in various ways, such as dispensing a beverage; replacing a consumable cartridge (e.g., ingredient cartridge(s) 202, gas cylinder 301, filter cartridge 402); maintaining or servicing system 100; or remotely interacting with system 100.

In some embodiments, a method of installing an ingredient cartridge 202 includes: optionally removing drip tray 160; opening door 150; moving lever 231 from the closed position to the open position; removing existing ingredient cartridge 202 (if present); removing seal 214 (if present); placing a new ingredient cartridge 202 in ingredient cartridge slot 221; and moving lever 231 from the open position to the closed position to sealingly couple ingredient cartridge 202 to lever system 230. In some embodiments, moving lever 231 from the open position to the closed position creates a flow path from an internal volume 206 of ingredient cartridge 202 to nozzle 118, as described above and shown in FIG. 20. In some embodiments, display 502 is configured to display instructions of each step of the method of installing ingredient cartridge 202. In some embodiments, after identifier system 916 can detect the ingredient disposed in ingredient cartridge 202. If the new ingredient cartridge 202 includes a different ingredient than the existing ingredient cartridge 202, system 100 will notify user (e.g., on display 502) that the ingredients are different and prompt the user to run a cleaning cycle, for example using an cleaning cartridge (e.g., an ingredient cartridge 202 containing a cleaner). In some embodiments, the cleaning cartridge is installed using the same method described above. In some embodiments, after the cleaning cycle, the cleaning cartridge is replaced with a new ingredient cartridge 202 using the same method described above.

In some embodiments, a method of installing a gas cylinder 301 includes: optionally removing drip tray 160; opening door 150; moving lever 331 from the closed position to the open position; removing existing gas cylinder 301 (if present); placing a new gas cylinder 301 in gas system 300, for example, by placing flange 304 in slot 333; and moving lever 331 from the open position to the closed position to sealingly couple gas cylinder 301 to lever system 330. In some embodiments, moving lever 331 from the open position to the closed position creates a flow path from an internal volume of gas cylinder 301 to nozzle 118, as described above and shown in FIG. 20. In some embodiments, display 502 is configured to display instructions of each step of the method of installing gas cylinder 301.

In some embodiments, a method of installing a filter 402 includes: optionally removing drip tray 160; opening door 150; moving lever 431 from the closed position to the open position; removing existing filter cartridge 402 (if present); placing a new filter cartridge 402 in filter system 400, for example, by placing flange 404 in slot 433; and moving lever 431 from the open position to the closed position to sealingly couple filter cartridge 402 to lever system 430. In some embodiments, moving lever 431 from the open position to the closed position creates a flow path from water source 702, through filter system 400 and to nozzle 118, as described above and shown in FIG. 20. In some embodiments, display 502 is configured to display instructions of each step of the method of installing filter cartridge 402.

As used herein, the terms “upper” and “lower,” and “top” and “bottom,” and the like are intended to assist in understanding of embodiments of the disclosure with reference to the accompanying drawings with respect to the orientation of system 100 and various components of system 100 as shown, and are not intended to be limiting to the scope of the disclosure or to limit the disclosure scope to the embodiments depicted in the Figures. The directional terms are used for convenience of description and it is understood that system 100 and components of system 100 may be positioned in any of various orientations.

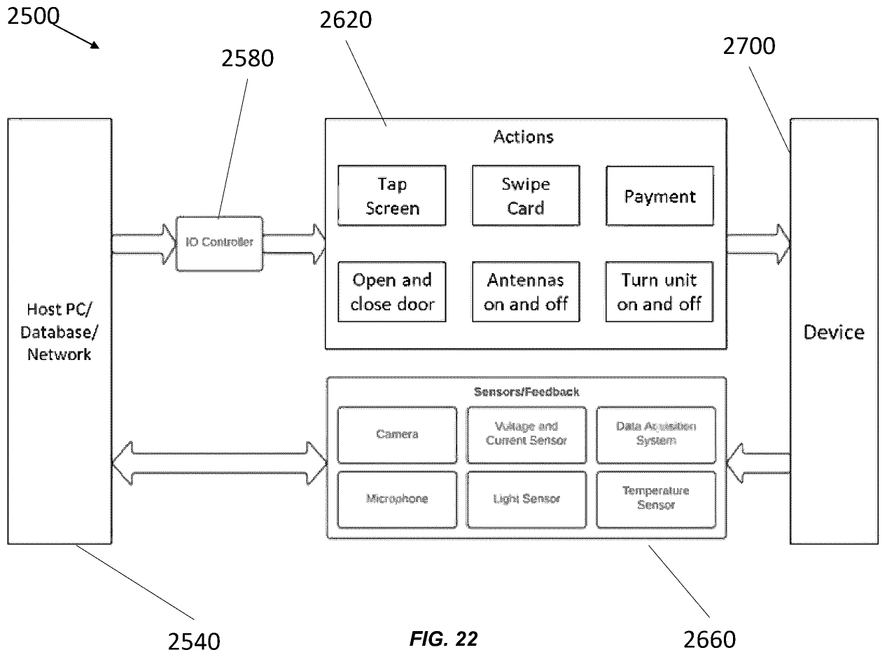

FIG. 22 illustrates system 2500 that shows communications among various components of system 100 and a remote device. communication systems according to some embodiments. System 2500 can include Host PC 2540, I/O controller 2580, action 2620, sensors 2660, and device 2700. In some embodiments, device 2700 is system 100.

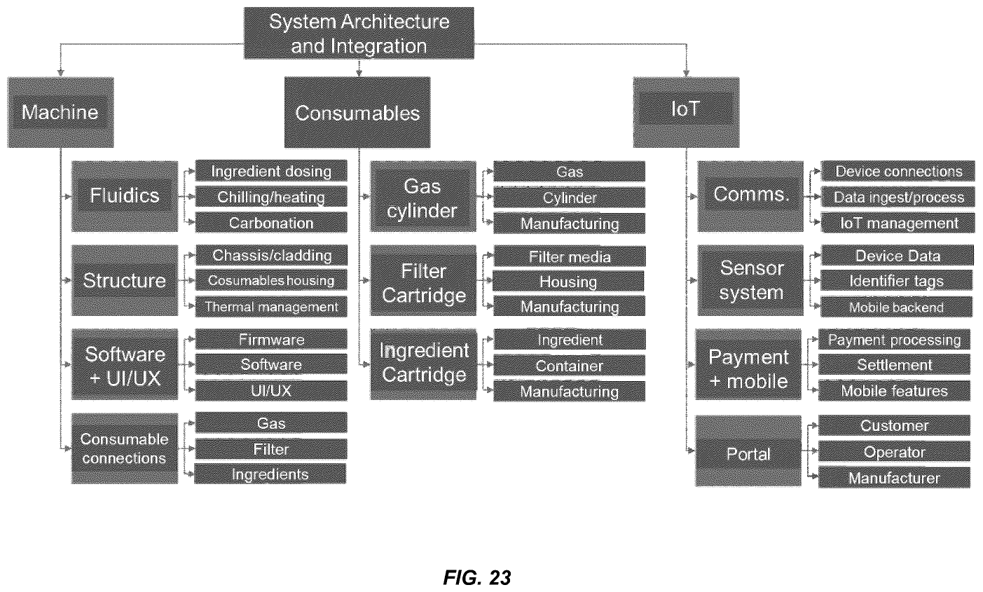

FIG. 23 shows a flowchart illustrating the integration of various components described herein. As shown in FIG. 23, system 100 and consumable (e.g., ingredient cartridge 202, gas cylinder 301, and filter cartridge 402) can all be integrated with an IoT system.

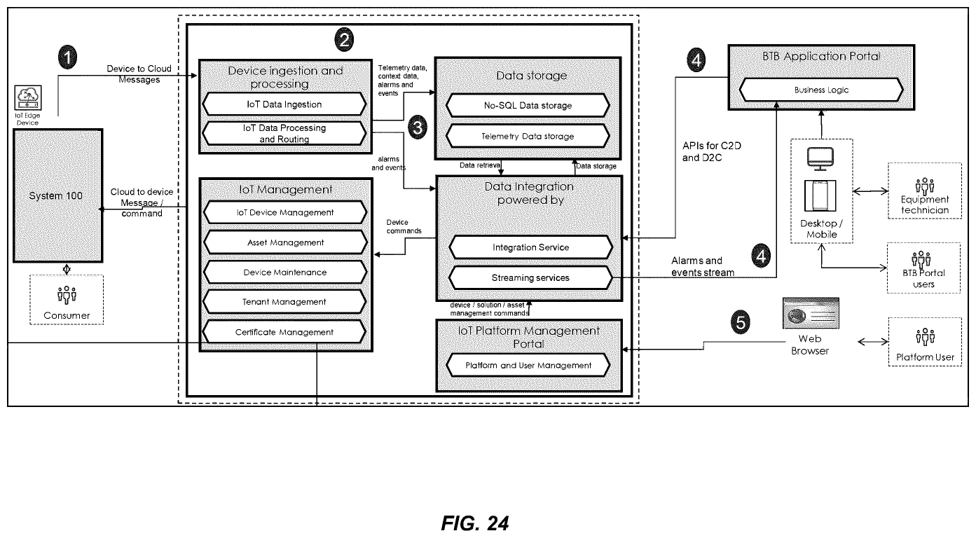

FIG. 24 shows a flowchart illustrating the integration of various components of various components. For example, as illustrated, system 100 can be part of a larger network and can communicate with various components of the larger network. For example, as illustrated system 100 can communicate with device ingestion and processing systems, IoT management systems, data storage systems, data integration systems, IoT platform management portals, user portals, remote devices, web browsers, technicians, portal users, and platform users (i.e., end users).

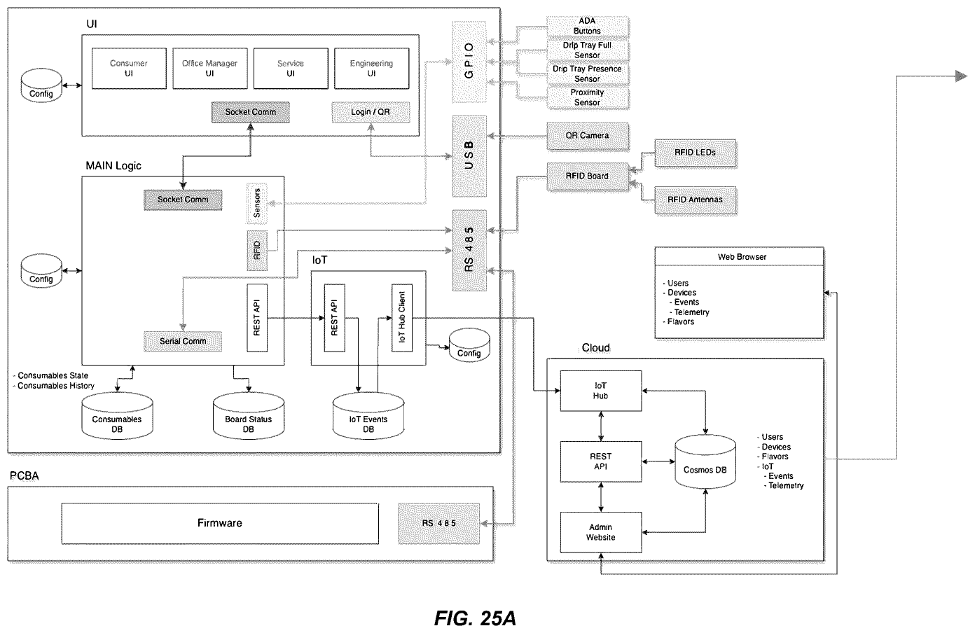

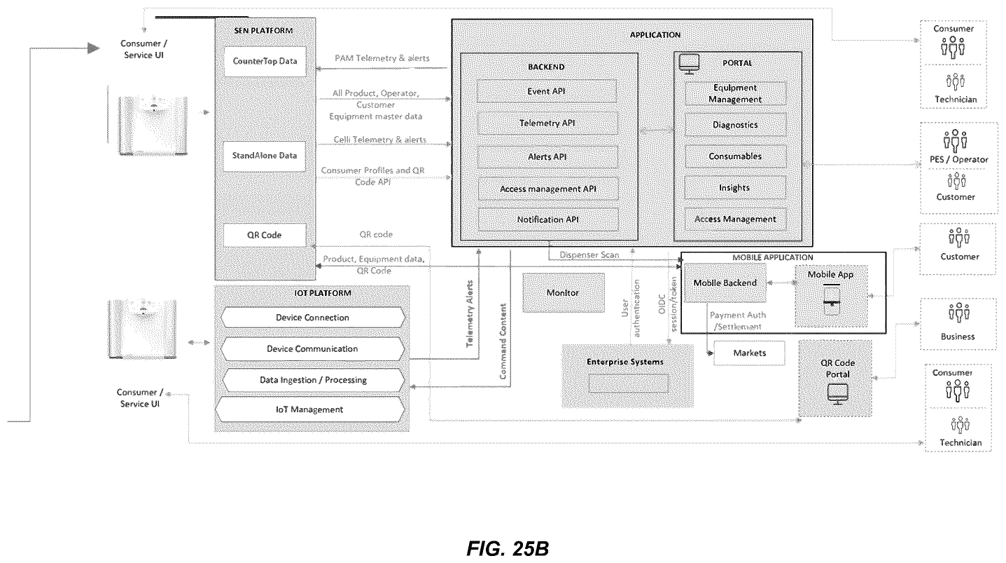

FIGS. 25A and 25B illustrate various systems that can be part of the network of systems illustrated in FIG. 24. For example, FIG. 25 illustrates systems that can be local to system 100, and FIG. 25B illustrates systems that can be remote from system 100.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

What is claimed is:

1. A water filter cartridge mount for a beverage dispenser, the water filter mount comprising:
a wall;
a slot configured to receive a first portion of a water filter cartridge;
a filter coupling assembly, the filter coupling assembly comprising:
a receptacle for receiving a second portion of the water filter cartridge,
a water inlet in fluid communication with a water source;
a water outlet; and
a valve,
wherein the filter coupling assembly is configured to secure the water filter cartridge to the water filter mount,
wherein the filter coupling assembly is configured to be moved between a sealed position and an unsealed position,
wherein the filter coupling assembly is configured to be sealingly coupled to the water filter cartridge in the sealed position, and
wherein the filter coupling assembly is not coupled to the water filter cartridge in the unsealed position; and
a lever system coupled to the filter coupling assembly and comprising a lever configured to move between a closed position and an open position,
wherein the filter coupling assembly is configured to move from the unsealed position to the sealed position in response to the lever moving from the open position to the closed position.

2. The water filter cartridge mount of claim 1, wherein the lever is rotatable about an axis, and wherein the filter coupling assembly is movable vertically between the sealed position and the unsealed position.

3. The water filter cartridge mount of claim 2, wherein the lever system is coupled to the filter coupling assembly by a cam such that the filter coupling assembly moves vertically up in response to the lever moving from the closed position to the open position and the filter coupling assembly moves vertically down in response to the lever moving from the open position to the closed position.

4. The water filter cartridge mount of claim 1, further comprising:
a first C-shaped rim extending perpendicular out from the wall; and
a second C-shaped rim disposed below the first C-shaped rim, the second C-shaped rim extending perpendicular out from the wall,
wherein the slot is defined by a space between the first C-shaped rim and the second C-shaped rim.

5. The water filter cartridge mount of claim 4, wherein the second C-shaped rim extends out from the wall farther than the first C-shaped rim.

6. The water filter cartridge mount of claim 1, wherein the open position is about 90 degrees relative to the closed position.

7. The water filter cartridge mount of claim 1, further comprising:
the water filter cartridge, wherein the water filter cartridge comprises:
a filter head comprising a flange, a filter water inlet, and a filter water outlet;
a filter housing coupled to the filter head, and
filter media disposed within the filter housing.

8. The water filter cartridge mount of claim 7, further comprising a water flow path that is formed when the lever is in the closed position and the filter coupling assembly is in the sealed position, wherein the flow path extends from the water inlet and through the filter water inlet, the filter media, the filter water outlet, and the water outlet.

9. The water filter cartridge mount of claim 7, wherein the slot is configured to receive the flange.

10. The water filter cartridge mount of claim 7, wherein the filter head comprises a valve disposed at the filter water inlet, wherein the valve is configured to open only when water pressure is applied to the valve.

11. The water filter cartridge mount of claim 1, wherein the valve of the filter coupling assembly is a check valve.

12. The water filter cartridge mount of claim 1, wherein the water outlet is in fluid communication with at least one of a nozzle of the beverage dispenser, a refrigeration system, or a heating system.

13. The water filter cartridge mount of claim 1, wherein the valve is configured to open only when water pressure is applied.

14. A gas cylinder mount for a beverage dispenser, the gas cylinder mount comprising:
a wall;
a slot configured to receive a portion of a gas cylinder;
a gas cylinder coupling assembly, the gas cylinder coupling assembly comprising:
a receptacle for receiving a head of the gas cylinder,
a regulator configured fluidly couple to the gas cylinder,
wherein the gas cylinder coupling assembly is configured to secure the gas cylinder to the gas cylinder mount,
wherein the gas cylinder coupling assembly is configured to be moved between an unsealed position, a locked position, and a sealed position,
wherein the gas cylinder coupling assembly is configured to be sealingly coupled to the gas cylinder in the sealed position, and
wherein the gas cylinder coupling assembly is not coupled to the gas cylinder in the unsealed position; and
a lever system coupled to the gas cylinder coupling assembly and comprising a lever configured to move between an open position, an intermediate position, and a closed position,
wherein the gas cylinder assembly is configured to move from the unsealed position to the locked position in response to the lever moving from the open position to the intermediate position, and
wherein the gas cylinder assembly is configured to move from the locked position to the sealed position in response to the lever moving from the intermediate position to the closed position.

15. The gas cylinder mount of claim 14, wherein the lever is rotatable about an axis, and wherein the a gas cylinder coupling assembly is movable vertically between the unsealed position, the locked position, and the sealed position.

16. The gas cylinder mount of claim 14, wherein the open position is about 90 degrees relative to the closed position, and wherein the intermediate position is about 10 degrees to about 30 degrees relative to the closed position.

17. The gas cylinder mount of claim 15, wherein the lever system is coupled to the gas cylinder coupling assembly by a cam such that the gas cylinder coupling assembly moves vertically up in response to the lever moving from the closed position to the open position and the filter coupling assembly moves vertically down in response to the lever moving from the open position to the closed position.

18. The gas cylinder mount of claim 14, further comprising:
a first C-shaped rim extending perpendicular out from the wall; and
a second C-shaped rim below the first C-shaped rim, the second C-shaped rim extending perpendicular out from the wall,
wherein the slot is defined by the space between the first surface and the second surface.

19. The gas cylinder mount of claim 18, wherein a height of the slot at the front of the slot is greater than a height of the slot at the back of the slot.

20. The gas cylinder mount of claim 14, further comprising a first O-ring disposed in the receptacle, and a second O-ring disposed in the receptacle below the first O-ring and spaced apart from the first O-ring.

21. The gas cylinder mount of claim 20, further comprising the gas cylinder, wherein the gas cylinder comprises a pin configured to be depressed to open a valve of the gas cylinder, and
wherein the gas cylinder coupling assembly is configured to depress the pin as the gas coupling assembly moves from the locked position to the sealed position.

22. The gas cylinder mount of claim 21, wherein the gas cylinder comprises an outlet disposed on a side of the head of the gas cylinder, wherein the opening aligns with the space between the first O-ring and the second O-ring.

23. The gas cylinder mount of claim 22, wherein the regulator comprises a gas inlet aligned with the space between the first O-ring and the second O-ring such that a flow path is formed from an interior of the gas cylinder, through gas cylinder outlet, through the space between the first O-ring and the second O-ring, and into the gas inlet of the regulator.

24. The gas cylinder mount of claim 14, wherein gas cylinder comprises a flange disposed around the head of the gas cylinder, wherein the slot is configured to receive the flange.

25. The gas cylinder mount of claim 14, wherein the gas cylinder coupling assembly is in fluid communication with a carbonator.

26. The gas cylinder mount of claim 14, wherein the gas cylinder comprises a valve configured to remain open when the lever is in the closed position.

27. An ingredient cartridge mount for a beverage dispenser, the ingredient cartridge mount comprising:
a receptacle comprising a recess configured to receive a base of the ingredient cartridge; and
a bottle press assembly comprising a hose configured to be removably and fluidly coupled to the ingredient cartridge,
wherein the bottle press assembly is configured to secure the ingredient cartridge to the ingredient cartridge mount,
wherein the bottle press assembly is configured to be moved between a sealed position and an unsealed position,
wherein the bottle press assembly is sealingly coupled to the ingredient cartridge in the sealed position, and
wherein the bottle press assembly is not coupled to the ingredient cartridge in the unsealed position;
a lever system coupled to the bottle press assembly and comprising a lever configured to move between a closed position and an open position,
wherein the bottle press assembly is configured to move from the unsealed position to the sealed position in response to the lever moving from the open position to the closed position.

28. The ingredient cartridge mount of claim 27, wherein the lever is rotatable about an axis, and wherein the bottle press is movable vertically between the sealed position and the unsealed position.

29. The ingredient cartridge mount of claim 27, wherein the open position is about 90 degrees relative to the closed position.

30. The ingredient cartridge mount of claim 28, wherein the lever system is coupled to the bottle press assembly by a cam such that the bottle press assembly moves vertically up in response to the lever moving from the closed position to the open position and the bottle press assembly moves vertically down in response to the lever moving from the open position to the closed position.

31. The ingredient cartridge mount of claim 27, wherein the hose comprises a first end configured to fluidly couple to the ingredient cartridge, wherein the hose narrows at the first end.

32. The ingredient cartridge mount of claim 27, wherein the hose comprises a second end in fluid communication with a pump configured to pump ingredients from the ingredient cartridge.

33. The ingredient cartridge mount of claim 32, wherein the pump is in fluid communication with a nozzle of the beverage dispenser, and
wherein, after extracting ingredient from the ingredient cartridge, the pump is configured to reverse pumping direction to retract ingredients between the pump and the nozzle.

34. An ingredient dosing system for a beverage dispensing system, the ingredient dosing system comprising:
a first ingredient cartridge mount, wherein the first ingredient cartridge mount is the ingredient cartridge mount of claim 27,
a second ingredient cartridge mount disposed horizontally next to the first ingredient cartridge mount,
a first ingredient cartridge coupled to the first ingredient cartridge mount;
a second ingredient cartridge coupled to the second ingredient cartridge mount;
a first pump fluidly coupled to the first ingredient cartridge mount and in fluid communication with a nozzle of the beverage dispensing system, the first pump configured to pump ingredients from the first ingredient cartridge; and
a second pump fluidly coupled to the second ingredient cartridge mount and in fluid communication with the nozzle of the beverage dispensing system, the second pump configured to pump ingredient from the second ingredient cartridge.

35. The ingredient dosing system of claim 34, wherein the first pump is in fluid communication with the first ingredient cartridge mount and the nozzle.

36. The ingredient cartridge dosing system of claim 35, wherein the second pump is in fluid communication with the second ingredient cartridge mount and the nozzle.

37. The ingredient cartridge dosing system of claim 34, wherein first pump and the second pump are independently operable.

38. The ingredient dosing system of claim 34, further comprising:
a third ingredient cartridge mount disposed vertically below the first ingredient cartridge mount;
a third ingredient cartridge coupled to the third ingredient cartridge mount;
a third pump fluidly coupled to the first ingredient cartridge mount and in fluid communication with a nozzle of the beverage dispensing system, the third pump configured to extract ingredients from the third ingredient cartridge.

39. An ingredient cartridge for a beverage dispenser, the ingredient cartridge comprising:
a body comprising:
sidewalls,
a base,
a neck portion, and
an interior volume defined in part by the side walls, the interior volume configured to store an ingredient; and
a closure, the closure comprising:
a sidewall;
a top portion, wherein the top portion comprises:
an upper surface and a lower surface opposite the upper surface,
a first opening configured to receive a hose, and
a second opening;
a straw coupled to the lower surface of the top portion at the opening to create a flow path into cartridge, the straw extending down into the interior volume; and
a membrane coupled to the lower surface of the top portion, wherein the membrane is a one-way vent configured to allow air flow into the interior volume as ingredients are removed from the interior volume.

40. The ingredient cartridge of claim 39, wherein the membrane seals the second opening such that liquid cannot exit ingredient cartridge at the second opening.

41. The ingredient cartridge of claim 39, wherein the ingredient cartridge is configured to receive the hose at the first opening such that the ingredient cartridge is fluidly coupled to the beverage dispenser.

42. The ingredient cartridge of claim 41, wherein the ingredient cartridge is configured to be removably and fluidly coupled to a pump, wherein the pump is configured to extract the ingredient from the interior volume.

43. The ingredient cartridge of claim 39, further comprising a rim disposed on the upper surface of the top portion and surrounding the first opening and the second opening.

44. The ingredient cartridge of claim 43, further comprising a seal removably coupled to the upper surface of the top portion, wherein the seal is configured to seal the first opening and the second opening.

45. The ingredient cartridge of claim 44, wherein the seal comprises foil.

46. The ingredient cartridge of claim 39, further comprising the ingredient disposed in the interior volume.

47. The ingredient cartridge of claim 39, wherein the closure comprises threads on an internal surface of the sidewalls, and wherein the neck portion comprises threads on an external surface.

48. The ingredient cartridge of claim 39, wherein the straw is integral with the top portion of the closure.

49. A beverage dispenser system, the beverage dispenser system comprising:
a water filter cartridge mount configured to receive a water filter cartridge;
a gas cylinder cartridge mount configured to receive a gas cylinder;
an ingredient cartridge mount configured to receive an ingredient cartridge; and
an electronics system comprising sensors configured to detect performance of the beverage dispenser.

50. The beverage dispenser of claim 49, wherein the electronics system is configured to communicate with a remote device, wherein the electronics system is configured to provide data to the remote device, wherein the data is related to at least one of the water filter cartridge, the gas cylinder, or the ingredient cartridge.

51. The beverage dispenser of claim 50, wherein the remote device is an artificial intelligence machine configured to provide feedback to the electronics system.

52. The beverage dispenser of claim 51, wherein the electronics system is configured to adjust at least one parameters based on the feedback from the artificial intelligence machine.

53. A method comprising:
training a machine learning model based on a dataset comprising product dispensing volume associated with one or more beverage dispensers, product distribution logistics records, and beverage dispenser component performance data; and
extracting from the model a prediction of at least one item selected from a group consisting of future sales volume of an existing product, consumer interest for new products, consumer interest for existing products and failure rates for components in beverage dispensing equipment.

54. The method of claim 53, wherein the dataset comprises sensor data collected from one or more beverage dispensers.

55. The method of claim 53, wherein the dataset comprises sales data collected from one or more beverage dispensers.

56. The method of claim 53, wherein the dataset comprises user preference data collected from one or more beverage dispensers.

57. The method of claim 53, further comprising developing a new beverage or flavor having a feature within the prediction of consumer interest for new beverages or flavors.
